(19) United States
(12) Patent Application Publication
(10) Pub. No.: US 2013/0318439 A1
(43) Pub. Date: Nov. 28, 2013

(54) ANALYTE TESTING METHOD AND SYSTEM WITH HIGH AND LOW ANALYTE TRENDS NOTIFICATION

(71) Applicants: Jeremy Landis, New York, NY (US); Salve Retuta Pascual, Washington, DC (US); Anita Mathew, Los Altos, CA (US)

(72) Inventors: Jeremy Landis, New York, NY (US); Salve Retuta Pascual, Washington, DC (US); Anita Mathew, Los Altos, CA (US)

(73) Assignee: Life Scan, Inc, Milpitas, CA (US)

(21) Appl. No.: 13/988,306

(22) PCT Filed: Nov. 4, 2011
(86) PCT No.: PCT/US11/59416

§ 371 Date: Aug. 12, 2013

Related U.S. Application Data
(63) Continuation of application No. 13/192,348, filed on Jul. 27, 2011.
Application No. 13/192,348 is a continuation of application No. 29/393,126, filed on May 31, 2011.
(60) Provisional application No. 61/415,598, filed on Nov. 19, 2010.
(60) Provisional application No. 61/469,046, filed on Mar. 29, 2011.

(51) Int. Cl. G06F 3/0488

(52) U.S. Cl. CPC G06F 3/0488
USPC 715/705

(57) ABSTRACT

Described herein are systems and methods to utilize factual information based on stored analyte data to allow greater insight into the management of diabetes of a user.

This application claims the benefits under 35 USC §§119, 120, 365, and/or the Paris Convention for prior provisional patent application Ser. Nos. 61/415,598 (Attorney Docket No. LFS5217USPSP) filed on Nov. 19, 2010; 61/469,046 (Attorney Docket No. LFS2222USPSP) filed on Mar. 29, 2011; U.S. Design patent application Ser. No. 29/393,126 filed on May 31, 2011 (Attorney Docket No. LFS5223USDP) and non-provisional patent application Ser. No. 13/192,348 (Attorney Docket No. LFS5217USNP) on Jul. 27, 2011, which prior applications are hereby incorporated by reference into this application in their entirety.

### BACKGROUND

Glucose monitoring is a fact of everyday life for diabetic individuals. The accuracy of such monitoring can significantly affect the health and ultimately the quality of life of the person with diabetes. Generally, a diabetic patient measures blood glucose levels several times a day to monitor and control blood sugar levels. Failure to test blood glucose levels accurately and on a regular basis can result in serious diabetes-related complications, including cardiovascular disease, kidney disease, nerve damage and blindness. There are a number of electronic devices currently available which enable an individual to test the glucose level in a small sample of blood. One such glucose meter is the OneTouch® Profile™ glucose meter, a product which is manufactured by LifeScan.

In addition to glucose monitoring, diabetic individuals often have to maintain tight control over their lifestyle, so that they are not adversely affected by, for example, irregular food consumption or exercise. In addition, a physician dealing with a particular diabetic individual may require detailed information on the lifestyle of the individual to provide effective treatment or modification of treatment for controlling diabetes. Currently, one of the ways of monitoring the lifestyle of an individual with diabetes has been for the individual to keep a paper logbook of their lifestyle. Another way is for an individual to simply rely on remembering facts about their lifestyle and then relay these details to their physician on each visit.

The aforementioned methods of recording lifestyle information are inherently difficult, time consuming, and possibly inaccurate. Paper logbooks are not necessarily always carried by an individual and may not be accurately completed when required. Such paper logbooks are small and it is therefore difficult to enter detailed information requiring detailed descriptors of lifestyle events. Furthermore, an individual may often forget key facts about their lifestyle when questioned by a physician who has to manually review and interpret information from a hand-written notebook. There is no analysis provided by the paper logbook to distill or separate the component information. Also, there are no graphical reductions or summary of the information. Entry of data into a secondary data storage system, such as a database or other electronic system, requires a laborious transcription of information, including lifestyle data, into this secondary data storage. Difficulty of data recordation encourages retrospective entry of pertinent information that results in inaccurate and incomplete records.

There currently exist a number of portable electronic devices that can measure glucose levels in an individual and store the levels for recalling or uploading to another computer for analysis. One such device is the Accu-Check™ Complete™ System from Roche Diagnostics, which provides limited functionality for storing lifestyle data. However, the Accu-Check™ Complete™ System only permits a limited selection of lifestyle variables to be stored in a meter. There is a no intelligent feedback from values previously entered into the meter and the user interface is unintuitive for an infrequent user of the meter. Another device is the Agamatrix WaveSense. However, the WaveSense does not provide for detection of high trend or low trend.

### SUMMARY OF THE DISCLOSURE

In a first embodiment, a mobile computing device is provided that includes a touch sensitive screen display, memory, one or more microprocessor, and program instructions. The touch-sensitive display is responsive to commands by finger contact with the at least one microprocessor coupled to the display and memory and provided with program instructions stored in the memory. The program instructions are executable by the at least one microprocessor to: generate at least one informational screen on the touch-sensitive display indicative of a plurality of analyte measurements stored in the memory; display a segmented selection button on the at least one informational screen upon finger contact longer than a preset time; overlay a help screen on the at least one informational screen upon momentary finger contact on one segmented selection button in which the help screen allows for help information to be displayed over the at least one informational screen; overlay a sharing screen on the at least one informational screen upon momentary finger contact on another segmented selection button that allows for information related to the at least one informational screen to be sent to a different device including another mobile computing device.

In this first embodiment, the following features may be utilized with either singly in any combination with this embodiment: the informational screen may include a screen selected from one of a logbook screen, a logbook screen with high low trends indicia, a graphical screen, or summary screen for the touch-sensitive display; the different device may be at least one of a desktop computer, server, printer, and combinations thereof. For this first embodiment, the at least one microprocessor is further programmed to: store a plurality of analyte measurements; determine whether a most recent analyte measurement at a given time during a day is below a first threshold; evaluate whether at least one analyte measurement of the plurality of analyte measurements performed within a time frame of X hours about the given time of the most recent analyte measurement over a period of N days, is lower than the first threshold; ascertain whether at least two analyte measurements of the plurality of analyte measurements performed within a time frame of X hours about the given time of the most recent analyte measurement over a period of N days, are higher than the second threshold; and upon completion of the evaluate and ascertain, annunciate that in the same time frame of at least two days over the N number of days, the plurality of analyte measurements indicates a trend lower than the low threshold or a trend higher than a second threshold. It is noted that the annunciate may include a display of at least one trend and plurality of analyte measurements on the touch screen display of the mobile communication device in a table having multiple rows and multiple columns with respective row header and column header, the column header signifying different time periods during a day with subdivisions of each of the column header to signify a before meal or after meal analyte measurement within each time period of the day, and the row header signifying the date of each analyte measurement, and in which numerical values representing analyte values identified as part of one analyte trend are represented by a first indicia and as part of another analyte trend by a second indicia different from the first indicia.

In a second embodiment, a mobile computing device is provided that includes a touch sensitive screen display, memory, one or more microprocessor, and program instructions. The touch-sensitive display is responsive to commands by finger contact with the at least one microprocessor coupled to the display and memory and provided with program instructions stored in the memory. The program instructions are executable by the at least one microprocessor to: store a plurality of analyte measurements; determine whether a most recent analyte measurement at a given time during a day is below a first threshold; evaluate whether at least one analyte measurement of the plurality of analyte measurements performed within a time frame of X hours about the given time of the most recent analyte measurement over a period of N days, is lower than the first threshold; ascertain whether at least two analyte measurements of the plurality of analyte measurements performed within a time frame of X hours about the given time of the most recent analyte measurement over a period of N days, are higher than the second threshold; upon completion of the evaluate and ascertain, annunciate that in the same time frame of at least two days over the N number of days, the plurality of analyte measurements indicates a trend lower than the low threshold or a trend higher than a second threshold; generate at least one informational screen on the touch-sensitive display indicative of a plurality of analyte measurements stored in the memory; display a segmented selection button on the at least one informational screen upon finger contact longer than a preset time; overlay a help screen on the at least one informational screen upon momentary finger contact on one segmented selection button in which the help screen allows for help information to be displayed over the at least one informational screen; and overlay a sharing screen on the at least one informational screen upon momentary finger contact on another segmented selection button that allows for information related to the at least one informational screen to be sent to a different device including another mobile computing device.

In this second embodiment, the following features may be utilized with either singly in any combination with this embodiment: the informational screen may include a screen selected from one of a logbook screen, a logbook screen with high low trends indicia, a graphical screen, or summary screen for the touch-sensitive display, the different device may be at least one of a desktop computer, server, printer, and combinations thereof. It is noted that the microprocessor is programmed to display the plurality of analyte measurements on the display of the mobile communication device in a table having multiple rows and multiple columns with respective row header and column header, the column header signifying different time periods during a day with subdivisions of each of the column header to signify a before meal or after meal analyte measurement within each time period of the day, and the row header signifying the date of each analyte measurement, and in which numerical values representing analyte values identified as part of one analyte trend are represented by a first indicia and as part of another analyte trend by a second indicia different from the first indicia. Alternatively, the microprocessor is further programmed to confirm whether the most recent analyte measure was flagged as one of predetermined conditions including (a) a measurement made before a meal or (b) during a fasting period. The microprocessor is further programmed to confirm whether the most recent analyte measure is below a first threshold as the predetermined condition, and the N number of days may include any number from about 2 to about 14 and the X hours may include any number between about 0 and about 7 hours; the X hours may include any number from about 0 to about 3 hours; and the first threshold may include about 70 mg of glucose per deciliter of blood and the second threshold may include about 150 mg of glucose per deciliter of blood.

In a third embodiment, a method of notifying a user of high or low trends in blood glucose values is provided. The trend or trends may be obtained with an analyte measurement unit and used in conjunction with a mobile communication device, each having a microprocessor coupled to respective displays and memory storage devices. The method can be achieved by: transforming with the analyte measurement unit, an analyte in a physiological fluid into an enzymatic by-product and in the process provide a measurement of the analyte in the fluid; storing in the memory of the analyte measurement unit, one or more of the analyte measurements; determining with the mobile communication device, whether a most recent analyte measurement at a given time during a day is below a first threshold; evaluating with the mobile communication device, whether at least one analyte measurement of the plurality of analyte measurements performed within a time frame of X hours about the given time of the most recent analyte measurement over a period of N days, is lower than the first threshold; annunciating that, in the same time frame over the N number of days, the plurality of analyte measurements including the at least one analyte measurement indicates an analyte trend lower than the low threshold, the annunciating further may include: displaying an informational screen on the touch-sensitive display indicative of the analyte trend; displaying a segmented selection button on the at least one informational screen upon finger contact longer than a preset time; overlaying a help screen on the at least one informational screen upon momentary finger contact on one segmented selection button in which the help screen allows for help information to be displayed over the at least one informational screen.

In the third embodiment, the following features may be utilized with either singly in any combination with this embodiment: overlaying a sharing screen on the at least one informational screen upon momentary finger contact on another segmented selection button that allows for information related to the at least one informational screen to be sent to a different device including another mobile computing device.

In a fourth embodiment, a method of notifying a user of high or low trends in blood glucose values is provided. The trend or trends may be obtained with an analyte measurement unit and used in conjunction with a mobile communication device, each having a microprocessor coupled to respective displays and memory storage devices. The method can be achieved by: initiating with the analyte measurement unit, a physical transformation of an analyte in a physiological fluid into an enzymatic by-product and in the process provide a measurement of the analyte in the fluid; storing in the memory of the analyte measurement unit, one or more of the analyte measurements; determining whether a most recent analyte measurement at a given time during a day is above a second threshold; confirming whether the most recent analyte measure was flagged as (a) a measurement made before a meal or (b) a measurement made during a fasting period; evaluating with the mobile communication device, whether at least two analyte measurements of the plurality of analyte measurements performed within a time frame of X hours about the given time of the most recent analyte measurement over a period of N days, each is higher than the second threshold; annunciating that in the same time frame over the N number of days, the plurality of analyte measurements indicates an analyte trend higher than a second threshold, the annunciating further may include: displaying an informational screen on the touch-sensitive display indicative of the analyte trend; displaying a segmented selection button on the at least one informational screen upon finger contact longer than a preset time; overlaying a help screen on the at least one informational screen upon momentary finger contact on one segmented selection button in which the help screen allows for help information to be displayed over the at least one informational screen.

In this fourth embodiment, the following features may be utilized with either singly in any combination with this embodiment: overlaying a sharing screen on the at least one informational screen upon momentary finger contact on another segmented selection button that allows for information related to the at least one informational screen to be sent to a different device including another mobile computing device. It is noted that the annunciating may include: displaying a plurality of analyte measurements on the display of the mobile communication device in a table having multiple rows and multiple columns with respective row header and column header, the column header signifying different time periods during a day with subdivisions of each of the column header to signify a before meal or after meal analyte measurement within each time period of the day, and the row header signifying the date of each analyte measurement, and in which numerical values representing analyte values identified as part of one analyte trend are represented by a first indicia and as part of another analyte trend by a second indicia different from the first indicia. In this embodiment, the analyte may include glucose and the displaying may include showing a distribution of the first indicia of stored analyte for a trend of analyte measurements lower than the first threshold within a time frame of X hours about the given time of the most recent analyte measurement over a period of N days being connected to each other. Alternatively, the displaying may include showing a distribution of the second indicia of stored analyte for a trend of analyte measurements higher than the second threshold within a time frame of X hours about the given time of the most recent analyte measurement over a period of N days being connected to each other; the first indicia may include at least two circles with a connector in between, where the two circles comprise a first color; the second indicia may include at least two circles with a connector in between each of the circles, the circle comprising a second color; the recent N number of days may include any number from about 2 to about 14; the X hours may include any number between about 0 and about 7 hours; the X hours may include any number from about 0 to about 3 hours; the first threshold may include about 70 mg of glucose per deciliter of blood; the second threshold may include about 150 mg of glucose per deciliter of blood.

In a fifth embodiment, a diabetes management system is provided that includes at least one glucose test strip, measurement unit for the strip, and a mobile communication unit. The measurement unit may include a housing including a test strip port configured to receive the glucose test strip. The measurement microprocessor is coupled to the test strip port to provide data regarding an amount of glucose measured in a user's physiological fluid deposited on the test strip, the microprocessor further coupled to a memory. The mobile communication unit includes a mobile processor coupled to a display. One of the measurement microprocessor or the mobile microprocessor being programmed to: measure an analyte in a physiological fluid to provide an analyte measurement; store one or more of the analyte measurements; determine whether a most recent analyte measurement at a given time during a day is below a first threshold; evaluate whether at least one analyte measurement of the plurality of analyte measurements performed within a time frame of X hours about the given time of the most recent analyte measurement over a period of N days, is lower than the first threshold; ascertain whether at least two analyte measurements of the plurality of analyte measurements performed within a time frame of X hours about the given time of the most recent analyte measurement over a period of N days, are higher than the second threshold; and upon completion of one of the evaluate and ascertain, annunciate that in the same time frame of at least two days over the N number of days, the plurality of analyte measurements indicates a trend lower than the low threshold or a trend higher than a second threshold; generate at least one informational screen on the touch-sensitive display indicative of a plurality of analyte measurements stored in the memory; display a segmented selection button on the at least one informational screen upon finger contact longer than a preset time; overlay a help screen on the at least one informational screen upon momentary finger contact on one segmented selection button in which the help screen allows for help information to be displayed over the at least one informational screen; and overlay a sharing screen on the at least one informational screen upon momentary finger contact on another segmented selection button that allows for information related to the at least one informational screen to be sent to a different device including another mobile computing device.

In this fifth embodiment, the following features may be utilized with either singly in any combination with this embodiment: the processor is configured to display the plurality of analyte measurements on the display of the mobile communication device in a table having multiple rows and multiple columns with respective row header and column header, the column header signifying different time periods during a day with subdivisions of each of the column header to signify a before meal or after meal analyte measurement within each time period of the day, and the row header signifying the date of each analyte measurement, and in which numerical values representing analyte values identified as part of one analyte trend are represented by a first indicia and as part of another analyte trend by a second indicia different from the first indicia. Alternatively, the microprocessor is further programmed to confirm whether the most recent analyte measure was flagged as one of predetermined conditions including (a) a measurement made before a meal or (b) during a fasting period or the microprocessor is further programmed to confirm whether the most recent analyte measure is below a first threshold as the predetermined condition. It is noted that the recent N number of days may include any number from about 2 to about 14 and the X hours may include any number between about 0 and about 7 hours; the X hours may include any number from about 0 to about 3 hours; the first threshold may include about 70 mg of glucose per deciliter of blood and the second threshold may include about 150 mg of glucose per deciliter of blood.

In a sixth embodiment, a method of notifying a user of high or low trends in blood glucose values obtained with an analyte measurement unit and used in conjunction with a mobile communication device is provide. Each of the unit and device has a microprocessor coupled to memory storage devices. The mobile communication device includes a touch screen or touch-sensitive display. The method can be achieved by: initiating with the analyte measurement unit, a physical transformation of an analyte in a physiological fluid into an enzymatic by-product and in the process provide a measurement of the analyte in the fluid; storing in the memory of the analyte measurement unit, one or more of the analyte measurements; evaluating the one more of the analyte measurements to determine one or more of a high trend in which blood glucose values over a set time frame is increasing or a low trend in which blood glucose values over the set time frame is decreasing; displaying, on the touch screen, an informational screen indicative of the one or more analyte measurements including the high or low trend; upon contact of a finger on the informational screen for a duration longer than a timed threshold, displaying a segmented button that provides at least two finger selectable options; upon a finger tap on the informational screen of one of the at least two finger selectable options, annunciating information related to the informational screen indicative of the one or more analyte measurements including the high or low trend; or upon a finger tap on the informational screen of the other of the at least two finger selectable options, allowing data representing the informational screen to be sent to a different device including another mobile communication device, server, or printer.

In this sixth embodiment, the following features may be utilized with either singly in any combination with this embodiment: the at least two finger selectable options comprise a print option, a share option, or a help option; the informational screen may include a screen selected from one of a logbook screen, a logbook screen with high low trends indicia, a graphical screen, or summary screen.

These and other embodiments, features and advantages will become apparent to those skilled in the art when taken with reference to the following more detailed description of various exemplary embodiments of the invention in conjunction with the accompanying drawings that are first briefly described.

### BRIEF DESCRIPTION OF THE FIGURES

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1A illustrates a diabetes management system that includes an analyte measurement unit and a mobile communication device.

FIG. 1B illustrates, in simplified schematic, an exemplary circuit board for each of the analyte measurement unit and the mobile communication device.

FIG. 1C illustrates an alternate to FIG. 1A as a preferred screen for a Summary of a 14-Day Glucose Report.

FIG. 1D illustrates the same screen as in FIG. 1C with the ability to share this screen with another user or healthcare provider and a mode to obtain help in explaining the data on this screen.

FIG. 1E illustrates another screen in which data collected for the relevant day can be accessed by scrolling screen 42 up.

FIG. 1F illustrates an alternate screen which is less graphic intensive.

FIG. 1G illustrates a screenshot of a text intensive summary screen for average blood glucose values over a 14-day period that are broken out by time of day.

FIGS. 2A and 2B illustrate two variations on a logic for determining a low trend;

FIGS. 3A and 3B illustrate two variations on a logic for determining a high trend;

FIG. 4A illustrates a pop-up message to indicate a low trend while the touch screen or touch-sensitive display is in the summary screen.

FIG. 4B illustrates a detailed text screen that a user may select in response to the selection provided in the pop-up of FIG. 4A.

FIG. 4C illustrates a screen shot of a pattern screen that is broken out into two subscreens to inform the user of the number of patterns, type of pattern and when the data for the patterns occurred.

FIG. 5A illustrates a unique output for the logbook display of the mobile communication device.

FIG. 5B illustrates a screen generated that provides additional details for the low trend identified on July 25 to July 26 for the “Morning” time interval.

FIG. 5C illustrates an alternate screen of the logbook display that provides a logbook of the blood glucose values categorized by four different time periods.

FIG. 5D illustrates yet another alternate screen of the logbook that break out the blood glucose values by different time periods in a day and patterns of low and high.

FIG. 5E illustrates another function of the logbook with respect to the patterns of high and low glucose values by deemphasizing the blood glucose values that are not above or below the predefined range.

FIG. 6A illustrates a screen that allows the user to select between obtaining help for the interpretation of the trending patterns or sharing the log-book with others.

FIG. 6B illustrates a follow-up screen to allow the user to share via email or text messaging of the log-book in FIG. 6A.

FIG. 6C illustrates a screen that allows the user to select between obtaining help for the interpretation of the trending patterns, sharing the log-book with others, or printing the log-book results.

FIGS. 7A and 7B represent an alternate mode of annunciating measurement values over time to the user using a graphical approach.

FIG. 7C illustrates a graphical screen shot in which the data points within a predefined normal range have been deemphasized so that the low and high trend patterns can be recognizable.

FIG. 7D illustrates a message that can be provided once the user has touch upon a particular data point on one of the high and low trends.

FIG. 8 represents yet another mode of annunciating measurement values over a number of days during the same time window using a graphical approach.

### MODES OF CARRYING OUT THE INVENTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. The term “analyte” may be read to include one or more substances in fluids that are the subject of a test to determine its quantity or quality. In addition, as used herein, the terms “patient,” “host,” “user,” and “subject” refer to any human or animal subject and are not intended to limit the systems or methods to human use, although use of the subject invention in a human patient represents a preferred embodiment.

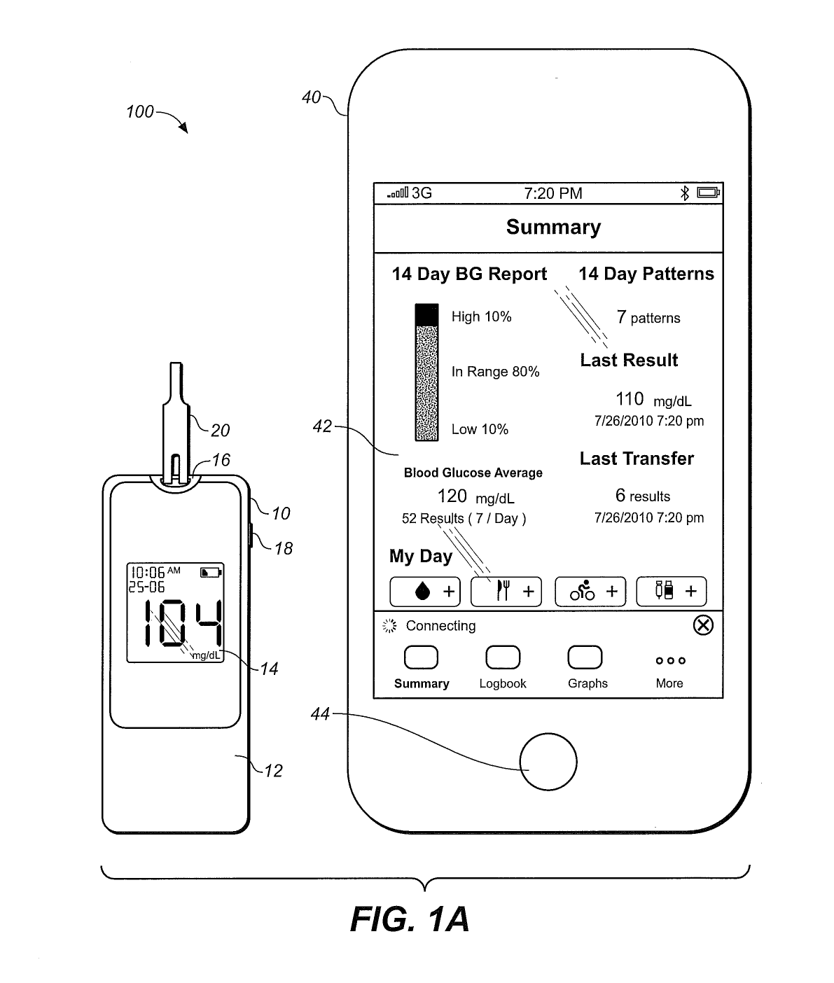

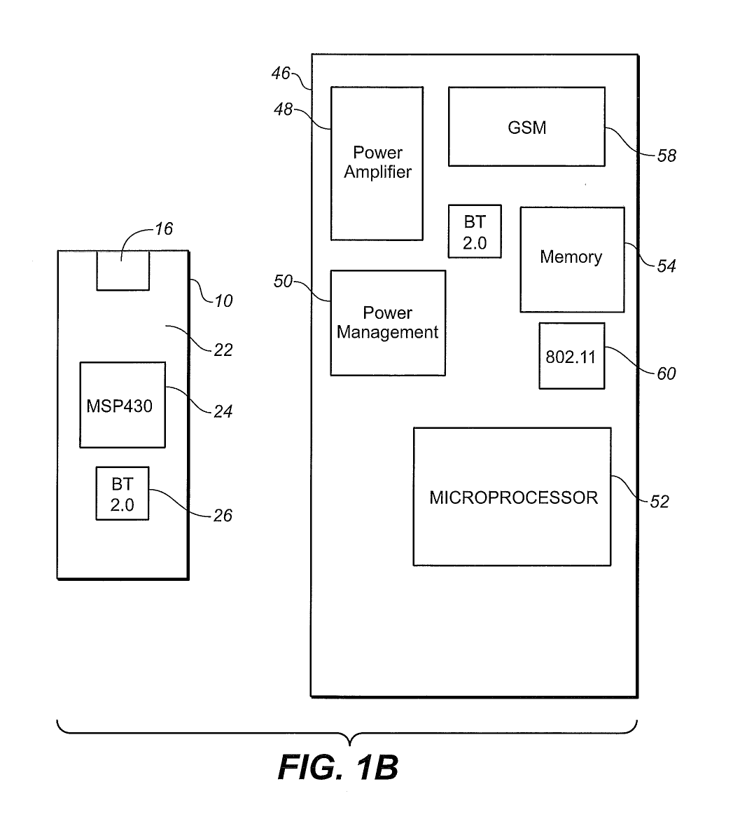

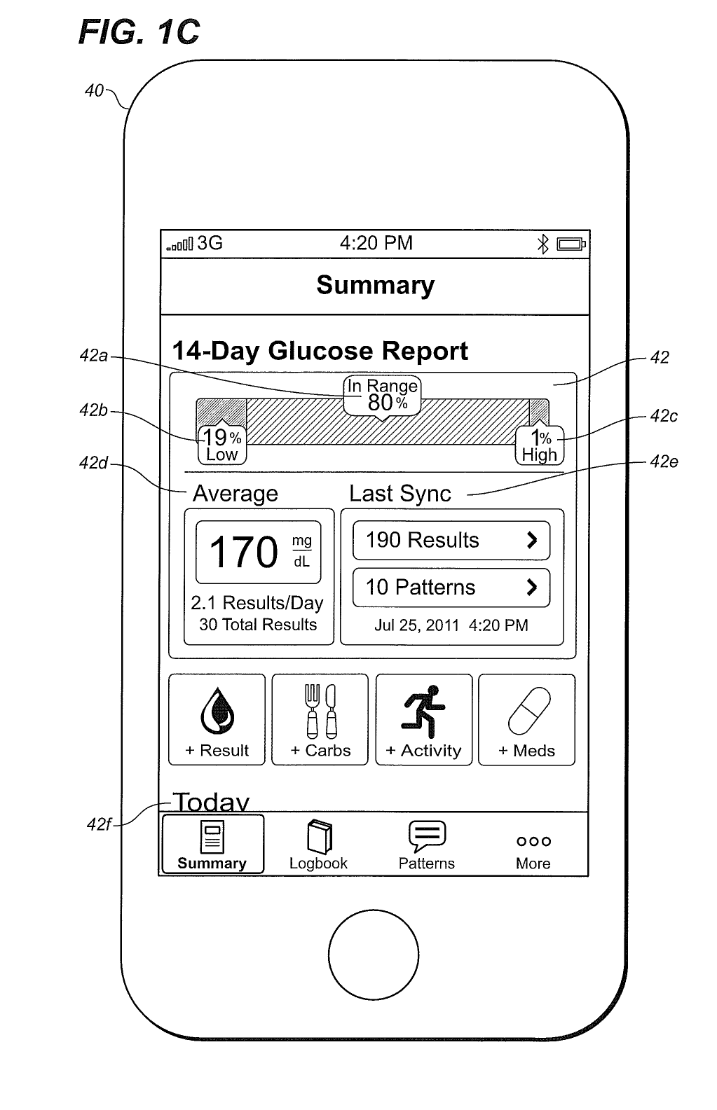

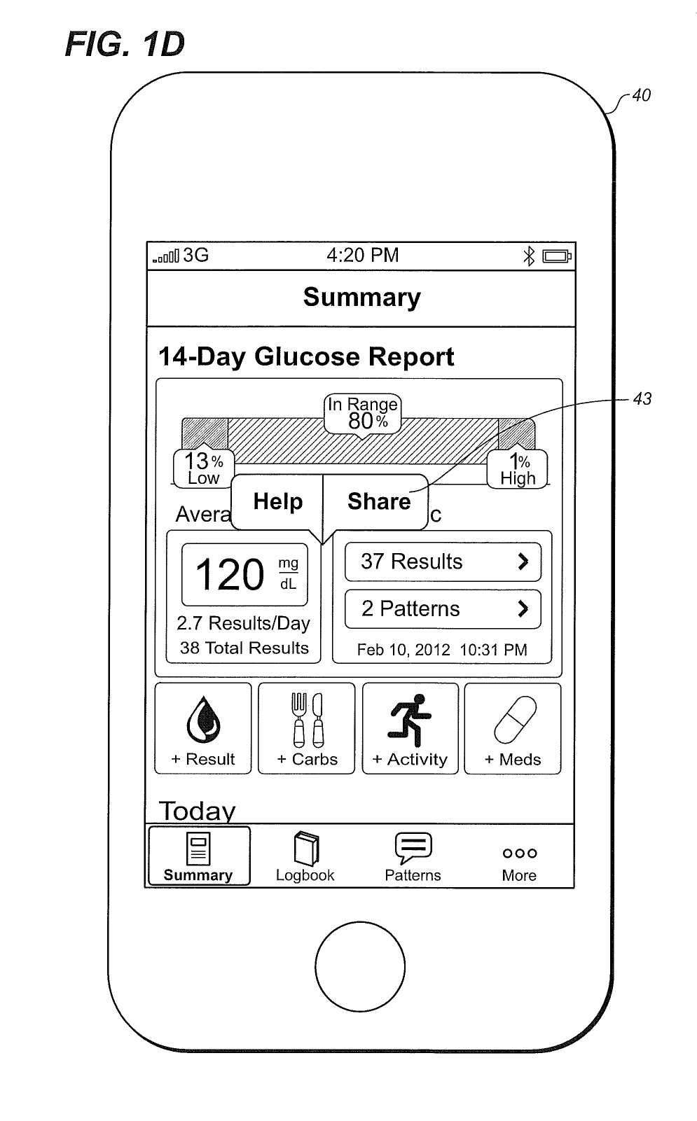

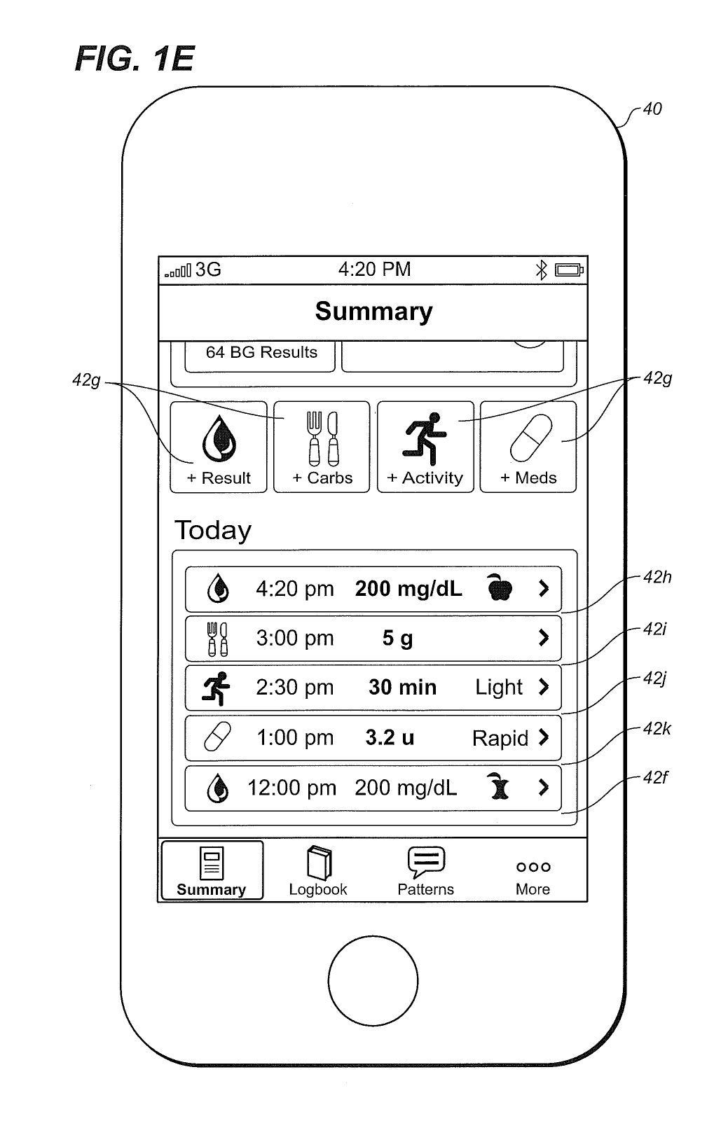

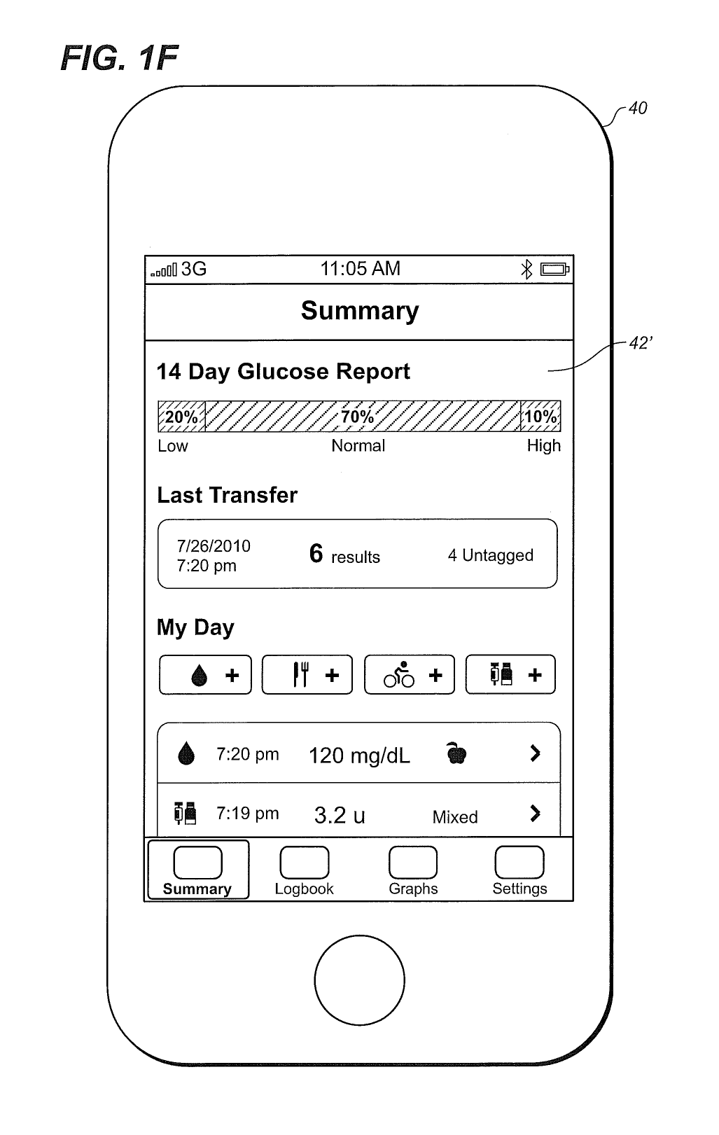

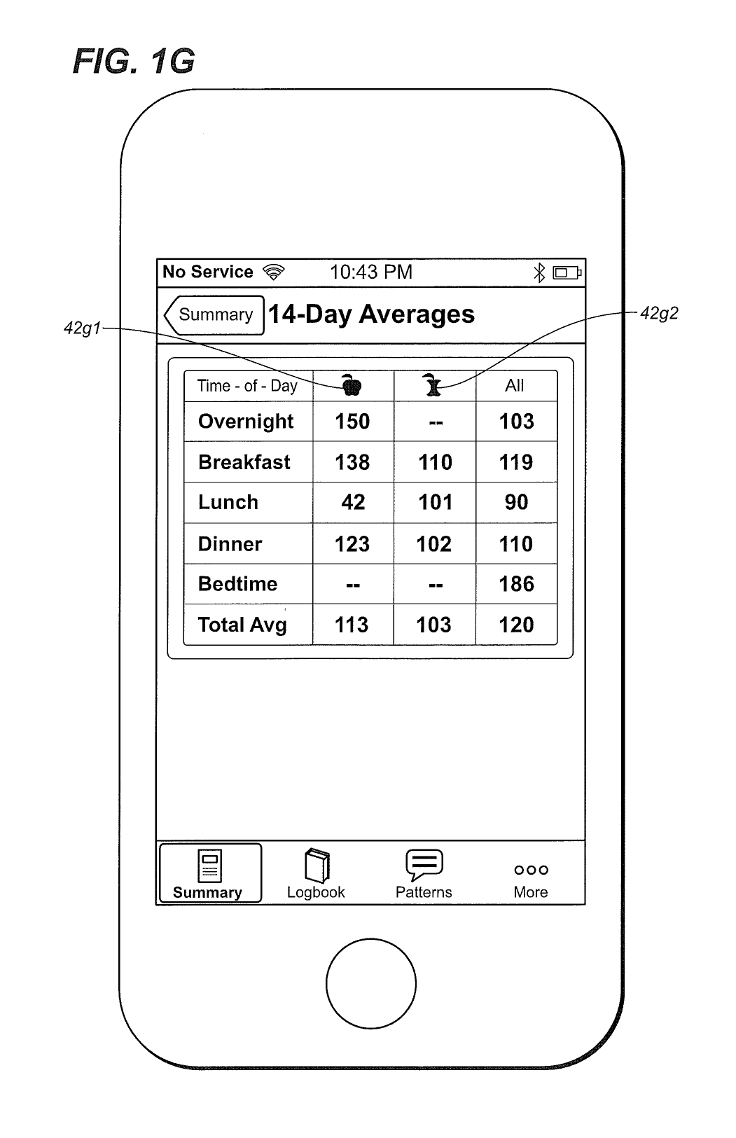

FIG. 1A illustrates a diabetes management system 100 that includes an analyte measurement unit 10 (“AMU”) in the form of a glucose sensor for use with a biosensor and a mobile communication device 40. The biosensor is in the form of a glucose test strip 20. Glucose meter or AMU 10 can include a housing 12, a display 14, a strip port connector 16, and a data port 18, as illustrated in FIG. 1A. Although no button is shown, a touch screen or touch-sensitive display with at least one mechanical switch or virtual buttons may be utilized with the meter 10. The communication device 40 includes the display 42 preferably a touch screen type display with a mechanical home switch 44.

FIG. 1B illustrates (in simplified schematic form) the electronic components of the AMU 10 disposed on a top surface of circuit board 22. The electronic components on circuit board 22 include a strip port connector 16, a microcontroller 24, and a first wireless module 26. The electronic components may also include a display connector (not shown for brevity), a non-volatile memory (not shown for brevity), a clock (not shown for brevity), a battery connector (not shown) and a data port 18. Microcontroller 24 can be electrically connected to strip port connector 16, operational amplifier circuit (not shown for brevity), wireless module 26, display 14, non-volatile memory (not shown for brevity) clock (not shown for brevity), battery (not shown for brevity), and data port 18.

Operational amplifier circuit (not shown for brevity) can include two or more operational amplifiers configured to provide a portion of the potentiostat function and the current measurement function. The potentiostat function can refer to the application of a test voltage between at least two electrodes of a test strip. The current function can refer to the measurement of a test current resulting from the applied test voltage. The current measurement may be performed with a current-to-voltage converter. Microcontroller 24 can be in the form of a mixed signal microprocessor (MSP) such as, for example, the Texas Instrument MSP 430. The MSP 430 can be configured to also perform a portion of the potentiostat function and the current measurement function. In addition, the MSP 430 can also include volatile and non-volatile memory. In another embodiment, many of the electronic components can be integrated with the microcontroller in the form of an application specific integrated circuit (ASIC).

Strip port connector 16 can be configured to form an electrical connection to the test strip. Display 14 can be in the form of a liquid crystal display for reporting measured glucose levels, and for facilitating entry of lifestyle related information. Display 14 can optionally include a backlight. Alternatively, display 14 may include a touch-screen display to allow for entry of data and responses without requiring buttons and switches. Data port 18 can accept a suitable connector attached to a connecting lead, thereby allowing AMU 10 to be linked to an external device such as a personal computer or allow rechargeable battery of the meter 10 to be recharged. Data port 18 can be any port that allows for transmission of data such as, for example, a serial, USB, or a parallel port. Preferably, data port 18 is in the form of a USB 2.0 port. Clock (not shown for brevity) can be configured to keep current time related to the geographic region in which the user is located and also for measuring time. The AMU 10 can be configured to be electrically connected to a power supply such as, for example, a battery.

The AMU 10 is designed to work with a suitable analyte test strip (e.g., electrochemical or photochemical) that provides for one or more measurements of analytes in physiological fluid such as, for example, glucose, ketone, cholesterol and the like. In one exemplary embodiment, test strip 20 can be in the form of an electrochemical glucose test strip. Test strip 20 can include one or more working electrodes and a counter electrode. Test strip 20 can also include a plurality of electrical contact pads, where each electrode can be in electrical communication with at least one electrical contact pad. Strip port connector 16 can be configured to electrically interface to the electrical contact pads and form electrical communication with the electrodes. Test strip 20 can include a reagent layer that is disposed over at least one electrode. The reagent layer can include an enzyme and a mediator. Exemplary enzymes suitable for use in the reagent layer include glucose oxidase, glucose dehydrogenase (with pyrroloquinoline quinone co-factor, “PQQ”), and glucose dehydrogenase (with flavin adenine dinucleotide co-factor, “FAD”). An exemplary mediator suitable for use in the reagent layer includes ferricyanide, which in this case is in the oxidized form. The reagent layer can be configured to physically transform glucose into an enzymatic by-product and in the process generate an amount of reduced mediator (e.g., ferrocyanide) that is proportional to the glucose concentration. The working electrode can then measure a concentration of the reduced mediator in the form of a current. In turn, AMU 10 can convert the current magnitude into a glucose concentration. Details of the preferred test strip are provided in U.S. Pat. Nos. 6,179,979; 7,045,046; 7,291,256; 7,498,132, all of which are incorporated by reference in their entireties herein.

Referring again to FIG. 1B, a circuit board 46 of the hand-held computing unit 40 is shown with certain components disposed thereon in schematic form. A power amplifier chipset 48 along with a power management chipset 50 is provided for a microprocessor 52, which is coupled to a memory chipset 54, wireless communication module 56 (e.g. Bluetooth 2.0), GSM or GPRS chipset 58, and Wi-Fi chipset 60. Examples of commercially available portable communication device include the Blackberry Torch Smartphone, Android Smartphone, iPhone, iPod Touch, iPad, and others from Nokia, LG, Samsung, and Motorola. It should be noted that the portable communication device for use herein does not have to be smartphone but may include any hand-held portable computing device with the ability to communicate data to a server and back. Preferably, the portable communication device includes the iPhone 4G and the iPod Touch.

In operation, a patient may begin the use of system 100 by performing a blood test. Specifically, a suitable test strip 20 is inserted into the AMU 10 to turn on the device. Blood or a suitable physiological fluid is extracted by a suitable device (e.g., a lancet) and deposited on a distal end of the strip 20. Deposition of blood initiates a physical transformation of the analyte (e.g., glucose) into an enzymatic by-product such as, for example, gluconic acid, thereby allowing the AMU 10 to measure current flow from the enzymatic reaction in a test chamber of the test strip. After the enzymatic reaction has taken place and the current from the reaction measured, analyte result or in the exemplary embodiment, a blood glucose (“BG”) result at 202 is annunciated to the user. As used here, the term “annunciated” and variations on the root term indicate that an announcement may be provided via text, audio, visual or a combination of all modes of communication to a user.

The result from the electrochemical test is also transferred, if possible, immediately to the hand-held computing unit 40 for further processing in order to assist the user in management of the user's health or disease. The transfer of test result can be via a suitable wireless protocol such as, for example, WiFi, Zygbee, Bluetooth, CALM, and preferably via Bluetooth 2.0. Of course, the user could always enter the value manually using the touch screen or touch-sensitive display interface of the HCU 40 to write in the value using a finger tip and saving the data. Of note, whenever the meter 10 is connected to the nit 40 for transfer of data, a computer program containing software codes, identified here as an “App” checks the date and time stored in the meter. If the time difference is less than or equal to 15 minutes, the time of day in the meter is automatically updated to match the current time in the unit 40.

Various functionalities are provided by the App in the system 100, which functionalities are shown and described in Provisional U.S. Patent Application Ser. No. 61/308,217 filed 25 Feb. 2010 (Attorney Docket No. DDI-5194USPSP) and U.S. patent application Ser. No. 12/826,543(Attorney Docket No. DDI-5194USNP) filed 9 Jun. 2010, which are incorporated by reference in its entirety into this application. It should be noted that the functionalities described by the previously mentioned applications can be utilized in either the AMU 10 or the HCU 40, in part or in whole in either or both of these devices.

Once the blood glucose values have been transferred over to device 40 (manually or automatically), the user may immediately see the result and other related data, as shown in an informational screen which in this case is a summary screen of FIG. 1C. In this summary screen, provided on touch screen or touch-sensitive display 42, a presentation in the form of bar graph is shown where the percentage of readings 42a within a defined “in-range” or normal range with percentage of blood glucose readings 42b below the normal or predefined range is indicated along with the percentage of blood glucose readings 42c above the predefined range are shown on the bar graph. The summary screen also provides for a quick status on the average blood glucose value 42d from all of the readings or results stored in the device 40. This screen also allows for the user to determine when the last data transferred was made, number of results stored and number of patterns gleaned from the results via field 42e. The summary screen also allows the user to see the results collected for the current day by scrolling up field 42f. Of particular interest to health care provider or caretaker such as, for example, parents, teacher, or companions of the user is the ability for the user to share the summary screen by calling up the “help-share” functionality. This feature allows user to obtain more information on the data presented on the summary screen or to share the relevant or even the entire screen with another person. In particular, the data sharing feature allows users to send their 14 Day Glucose Report, Pattern messages, Logbook and Graph data to a destination via text or email.

The help-share functionality can be called up as follow. It is assumed that the device 40 in FIG. 1D is presently displaying on the touch screen 42 an informational screen indicative of the one or more analyte measurements. Upon contact of a finger or a suitable pointer on the informational screen for a duration longer than a timed threshold (e.g., 1-5 seconds), the device displays a segmented button 43 that provides at least two finger selectable options. Upon a tap by a finger or a suitable pointer on the informational screen of one of the at least two finger selectable options 43, the device 40 annunciates helpful information related to the informational screen indicative of the one or more analyte measurements including the high or low trend. Upon a tap on the informational screen of the other of the at least two finger selectable options, the device 40 allows data representing the informational screen (or a screen-captured image) to be sent to a different device including another mobile communication device, server, or printer.

As shown in FIG. 1E, glucose test results for each of the past 14 days are displayed in summary screen 42′, organized by date starting with the current date, time of day, along with any tags 42g to indicate for example, test result, carbohydrate ingested, activity and medication. For example, in field 42h, the blood drop icon indicates that a blood test was performed at 420 pm with the result of 200 mg/dL before meal by virtue of the uneaten apple icon; field 42i shows that a meal via the fork and knife icon was consumed at 300 pm with 5 grams of carbohydrates ingested; field 42j indicates that there was physical exercise at 230 pm that was light in intensity for about 30 minutes; field 42k indicates that medication in the form of 3.2 units of rapid acting insulin was taken; and field 42f indicates that a blood test was conducted resulting in 68 mg/dL after a meal via the half-eaten apple icon.

Rather than reviewing the details of each and every day within the 14 day reporting period, the user may elect to view the data at a different level of abstraction, shown here in FIG. 1G. In FIG. 1G, the 14-day averages are presented in terms of partitions within a day, e.g., overnight, around breakfast, lunch, dinner, and bedtime and whether the average was before a meal or after a meal. Suitable icons may be utilized to indicate whether the average (or median) blood glucose was taken before meal or after a meal. In the preferred embodiments, the icon of an uneaten apple at 42g1 indicates a before meal status and the icon of an eaten apple at 42g2 indicates an after meal status.

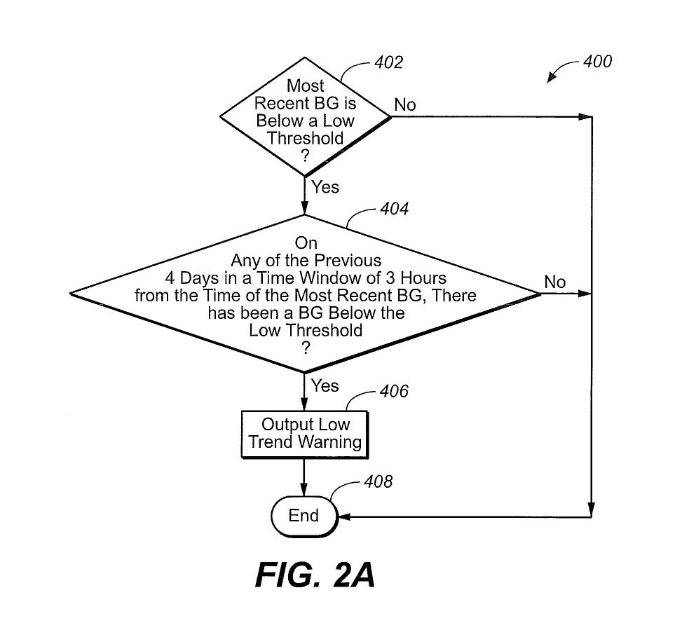

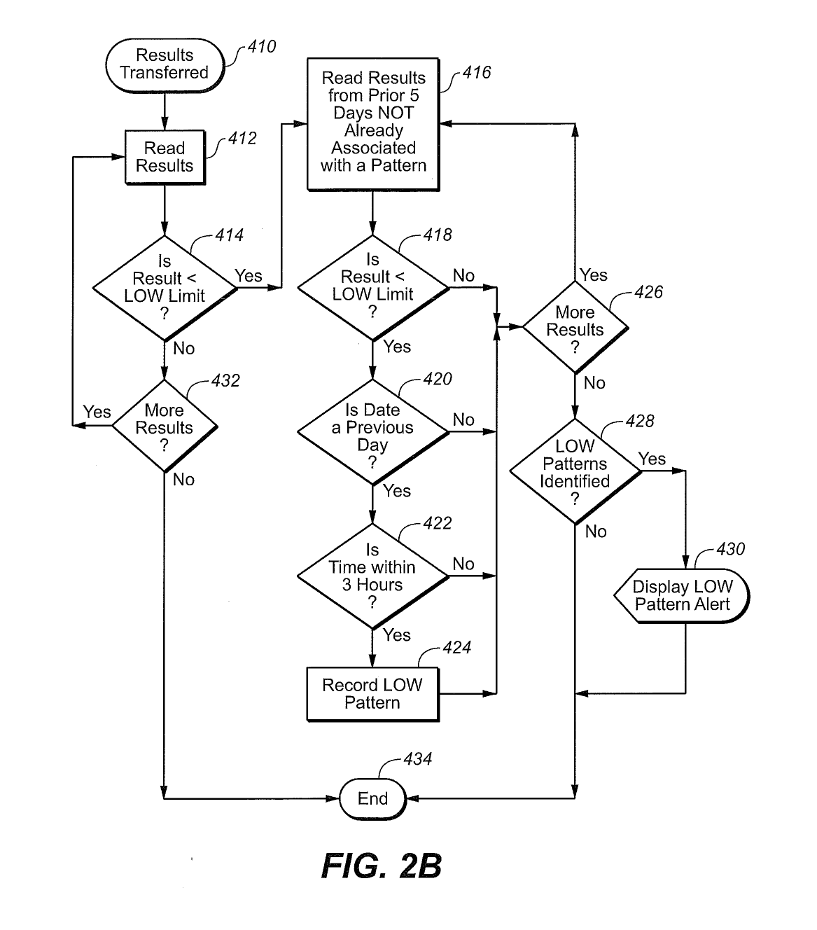

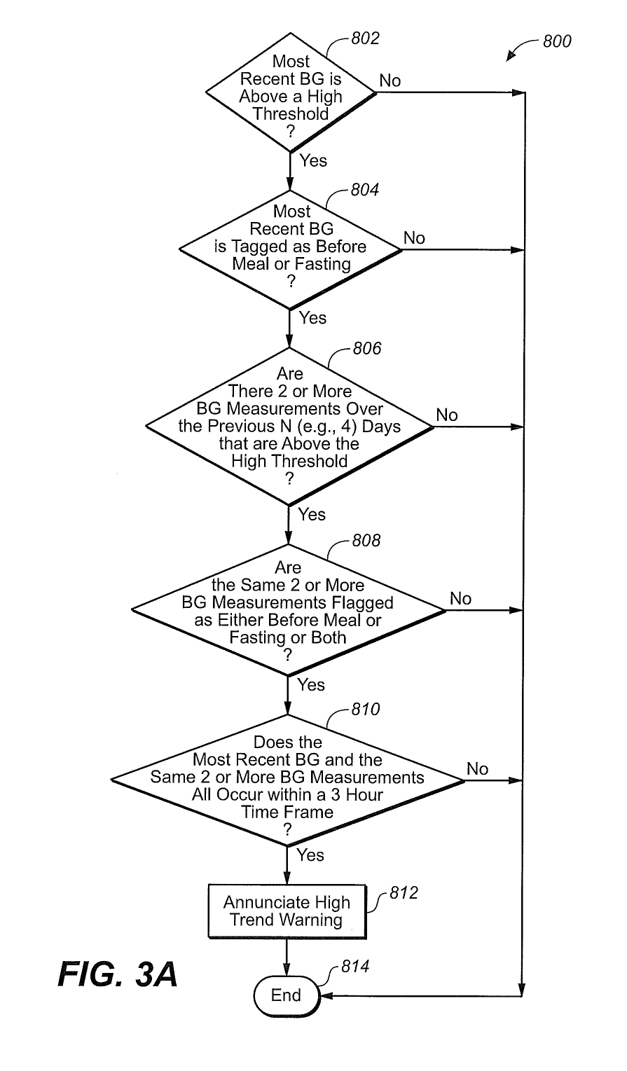

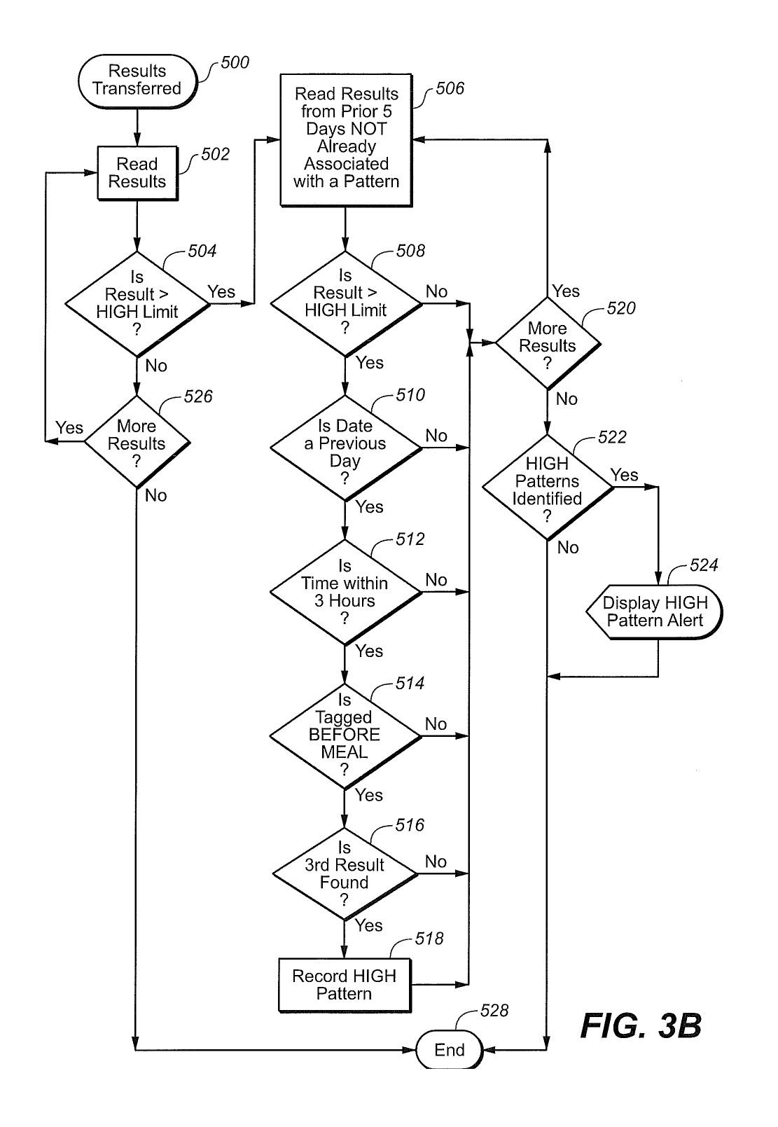

Another functionality is provided in the system 100 to allow for the device 40 to alert the user to a high trend (or a low trend) of the analyte measurements taken recently. Two variations on the logic for the low trend pattern detection is shown and described herein relation to FIGS. 2A and 2B whereas two variations on a logic for high-trend pattern detection are described in FIGS. 3A and 3B.

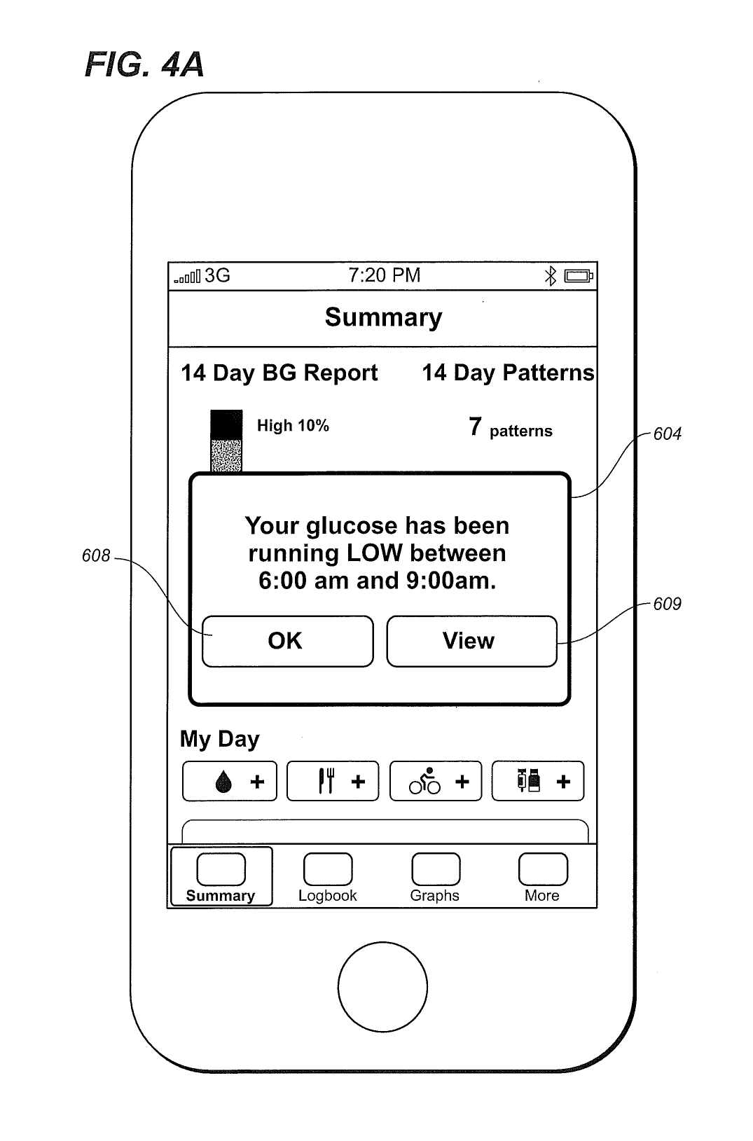

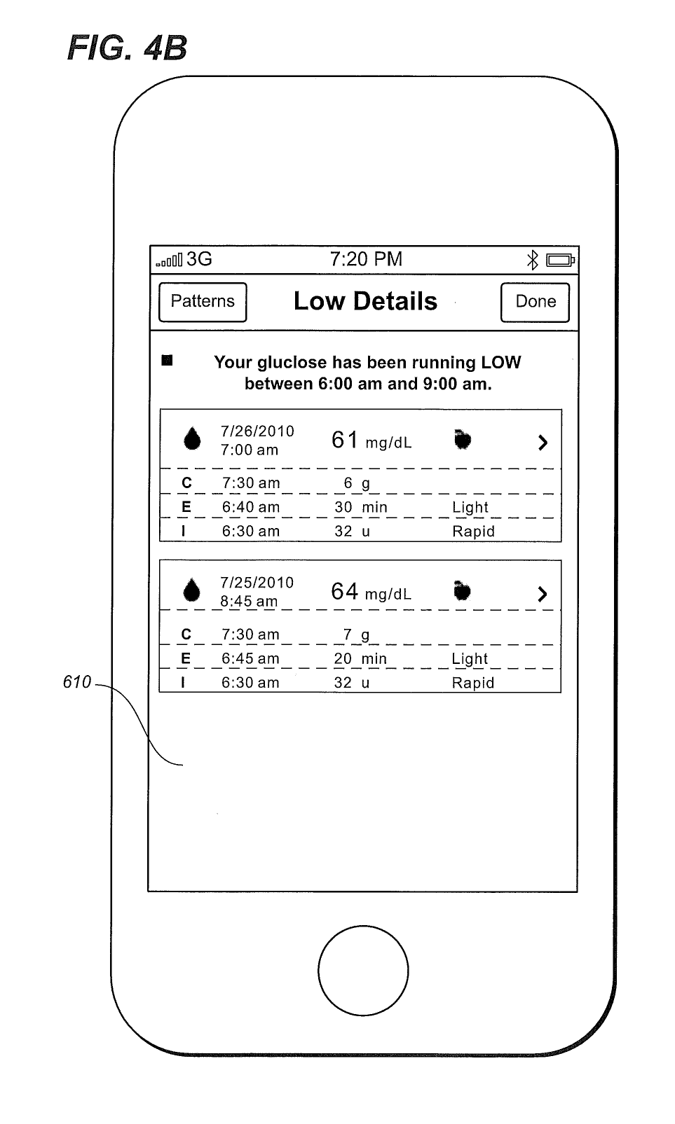

In FIG. 2A, the instant or most recent BG is compared at 402 to determine whether such BG result is below the low threshold. Note that the low threshold may also be referred to a first threshold. If true at 402, then the microprocessor determines at 404 whether at least one or more of the plurality of blood glucose measurements made within a window of X hours (e.g., approximately 3 hours from about 8 AM to about 11 AM) bracketing the same time period (9:30 AM) as the most recent BG measurement 602 were made in the most recent N number of days is lower than the low threshold. In one example, a BG result is 65 mg/dL, which is below the preset low threshold of about 70 mg/dL. The BG was taken at about 9:30 AM. On the basis of the logic described herein, the microprocessor 52 will look to its stored blood glucose measurements that were taken at a time frame of X hours bracketing the time (i.e., about 930 AM) at which the most recent blood measurement was made in the previous N number of days to determine whether at least one blood glucose measurement in such bracketed time frame about the given time (i.e., 930 AM) is lower than the low threshold. If at least one prior measurement fits this condition, the microprocessor annunciates a message 406 to warn of a low trend (e.g., FIG. 4A). In particular, as shown in FIG. 4A, at screen 604, a text message may pop-up, in any screen, to indicate that a low trend has been detected for the same time frame bracketing the given time at which most recent blood glucose measurement of 65 mg/dL was made. Where a user desires to view a last blood glucose result, screen 608 may be displayed and a selection for a low trend message 609 can be selected. Selection of the “view” button 609 allows the user to see details around the detection of the low trend such as, for example, a table listing the date, time, value of the BG results, and other contextual information relating to BG results such as, for example, exercise, food, or insulin drugs, as shown on screen 610 in FIG. 4B.

As an alternative to the logic of FIG. 2A, the logic of FIG. 2B can also be utilized. At 410, the logic flow begins with a transfer of one or more BG results from the AMU 10 to the hand-held computing unit 40. The processor 52 of the HCU 40 reads the BG results at 412 to begin the analysis for the low-pattern trend detection. At 414, a decision is made as to whether the result is lower than a pre-set low limit “LOW.” If true then the logic reads BG results collected from prior 5 days that are NOT utilized as part of any detected pattern. At 418, the logic checks to see if any of the results read at 416 are less than a LOW limit and if true, the logic flows to 420 where a decision is made to determine if at any time in the previous 5 days, a prior date BG (“Prior BG”) result is lower than the LOW limit. If true, the process flows to step 422 where it is determined as to whether the Prior BG result falls within a time window (e.g., 3 hours) spanning the time at which the most recent BG results was taken. In this example, if the most recent BG result was taken at 9:00 A.M., the Prior BG must be: (a) lower than the LOW limit; and (b) taken at any time between 6:00 AM and 12 noon on one of the prior 5 days. If true in 422, the program records these results as part of a low pattern 424. Returning back to decision 418, if the most recent result is equal to or greater than the LOW limit then the process flows to 426 at which the system checks to see if additional results were transferred while logic process from 414-424 was running. If true at 426, the process flow back to the excluder 416 and steps 418-424 are utilized once more. If false at 426, the process flows to decision 428 to determine if there are LOW patterns identified and stored in the HCU 40. If true, the HCU 40 annunciates a low pattern trend alert at 430.

Returning to process 414, if the process returns a false at 414, the flow proceeds to 432 to determine if there are updates to the results. Assuming that no new results were transferred while steps 412-424 were running, then the logic ends at 434.

A high trend detection logic 800 is also provided for the system, illustrated exemplarily here in FIG. 3A. To ensure proper operation of the high-trend pattern detection, a message may be provided in the device 40 to remind the user to tag or flag a BG measurement in order for high trends to be detected by the unit. Should the user persist in selecting the blank second threshold, a message is displayed to the effect that the tagging functionality must be enabled in order for high trends to be detected. This is intended to help users understand the relationship between the Before Meal limit and tagging. In other words, if tagging of before meal measurements are not made, then there is little value in providing high trend messages. Additionally, even if tagging is enabled, the user is reminded by message that tagging should be used consistently in order for the before meal high trend to be of value to the user.

In this logic flow of FIG. 3A, a logical query 802 is made as to whether a most recent BG result is above a high threshold. Note that the high threshold may also be referred to as a second threshold. If true, a logical query 804 as to whether the most recent BG result has been tagged as a Before Meal BG result or a Fasting BG result. If true, the logic flows to query 806 to determine whether 2 or more Prior BG measurements over the previous N number of days (e.g., 4 days) that are above the high threshold. If true, the logic flows to query 808 to determine whether the same 2 or more BG results have both been flagged as either a Before Meal BG result or a Fasting BG result. If true, the logic flows to query 810 to determine whether the most recent BG result and the same 2 or more Prior BG results all occur within X hours time frame. If true, the logic 800 annunciates a high trend warning at output 812. In queries 802-810, if the logic returns a false then the routine ends at 814. In the preferred embodiments, the variable N can be of any value from about 2 to 90 days and X can be of any value from about 1 hour to about 7 hours.

As an example of the logic 800, it will be assumed that a user conducted a series of measurements from Monday to Friday with a most recent BG result at 9 AM on Friday, as set forth in Table 1 below:

TABLE 1

| Day and Time | Status |
|---|---|
| Monday - 7:50AM | Exceeds High Threshold |
| | Flagged as Fasting BG result |
| Tuesday - 10:49AM | Exceeds High Threshold |
| | Flagged as Before Meal BG result |
| Wednesday - 7:40AM | Exceeds High Threshold |
| | Flagged as Fasting BG result |
| Thursday - 11:30AM | Exceeds High Threshold |
| | Flagged as Before Meal BG result |
| Friday - 9:00 AM | Exceeds High Threshold |
| (Most Recent BG result) | Flagged as Fasting BG result |

Referring to Table 1, the most recent BG has a logical true state for the logical queries 802 and 804 (i.e., exceeds the high threshold and flagged as fasting). At least one BG for each of the last four days has a logical true state for the logical queries 806 and 808. The logical query 810 must evaluate at least three BG's, which are the most recent BG (from queries 802 and 804) and the at least two BG's (from queries 806 and 808).

Based on the results collected in the previous 4 days, a warning message would be annunciated with the most recent BG on Friday at 9:00 AM. The 3 hour time bracket can include, in chronological order for time of day, 7:50 AM (Monday), 9:00 AM (Friday), and 10:49 AM (Tuesday), where the difference between the latest time and the earliest time is less than three hours (10:49 AM minus 7:50 AM=2 hours and 59 minutes). Thus, the Monday, Friday, and Tuesday BG's fall within the three hour time bracket. In addition to Monday, Friday, and Tuesday, the 3 hour time bracket can also include, in chronological order for time of day, 7:40 AM (Wednesday), 7:50 AM (Monday), and 9:00 AM (Friday), where the difference between the latest time and the earliest time is less than three hours (9:00 AM minus 7:40 AM=1 hour and 20 minutes).

Referring back to Table 1, there is no high trend alert for Wednesday. For Wednesday, 2 previous BG's and 1 most recent BG are evaluated in the logical query 810, which are 7:40 AM (Wednesday), 7:50 AM (Monday), and 10:49 AM (Tuesday), where the difference between the latest time and the earliest time is more than three hours (i.e., 10:49 AM minus 7:40 AM=3 hours and 9 minutes). Thus, the Wednesday, Monday, and Tuesday BG's do not fall within the three hour time bracket.

Referring back to Table 1, there is no high trend alert for Thursday. For Thursday, 2 previous BG's and 1 most recent BG are evaluated in the logical query 810. Note that there are three combinations of previous days that can be evaluated in the logical query 810, which are Monday/Tuesday; Monday/Wednesday; and Tuesday/Wednesday. Here, combining any one of the combinations of previous days with the most recent BG does not result in three BG's falling within the three hour time bracket.

Note that in the embodiment set forth in Table 1, only one glucose concentration per day was depicted that exceeds the high threshold and flagged as fasting. In other situations, there may be more than one glucose concentration per day that exceed the high threshold and are flagged as fasting. In such a case, the number of combinations of 3 BG's that need to be evaluated by the logic 800 will increase.

As a further demonstration of the applicability of logic routine 800, consider that the user further conducted a most recent BG measurement on the Saturday following the Friday (of Table 1), set forth herein Table 2.

TABLE 2

| Day and Time | Status |
|---|---|
| Monday - 750AM | Exceeds High Threshold |
| | Flagged as Fasting BG result |
| Tuesday - 10:49AM | Exceeds High Threshold |
| | Flagged as Before Meal BG result |
| Wednesday - 7:40AM | Exceeds High Threshold |
| | Flagged as Fasting BG result |
| Thursday - 11:30AM | Exceeds High Threshold |
| | Flagged as Before Meal BG result |
| Friday - 9:00 AM | Exceeds High Threshold |
| | Flagged as Fasting BG result |
| Saturday - 11:50AM | Exceeds High Threshold |
| (Most Recent BG) | Flagged as Before Meal BG result |

In Table 2, the logic 800 would detect a high trend alert on Saturday (at 11:50 AM), which would be annunciated with the most recent BG. Note that there are six combinations of previous days that can be evaluated in the logical query 810, which are Monday/Tuesday; Monday/Wednesday; Monday/Thursday; Tuesday/Wednesday; Tuesday/Thursday; and Wednesday/Thursday. The 3 hour time bracket can include, in chronological order for time of day, 10:49 AM (Tuesday), 11:30 AM (Thursday), and 11:50 AM (Saturday), where the difference between the latest time and the earliest time is less than three hours (i.e., 11:50 AM minus 10:49 AM=1 hour and 1 minute). Thus, the Tuesday, Thursday, and Saturday BG's fall within the three hour time bracket. In summary based on Table 2, the user would be provided two messages: one on Friday and another message on Saturday. Alternatively, however, only one message may be generated on Saturday that reports the two high trends by prioritization of the trend data. Prioritization of the high trend or low trend reports can be based on the following: once a glucose value is used for a (high or low) trend, it will no longer be included in other (high/low) trends; if multiple trends are detected, the tightest clustering of results will be the one reported; or if there are multiple high and low BG measurements within an hour, only the first low or high BG measurements will be included in trend analysis (i.e., if there are either multiple high values with an hour or multiple low values within an hour, only the first will be included in trend analysis). Alternatively, the prioritization can be based on based on chronological closeness or based on the tightness of the clustering which can be determined by the closest 2 BG results in time to the most recent BG result, or the closest 3 BG results in time to the most recent BG result.

An alternate logic may also be utilized to detect high BG trend(s), illustrated exemplarily here in FIG. 3B. In FIG. 3B, the logic flow begins at 500 with a transfer of one or more BG results from the AMU 10 to the hand-held computing unit 40. The processor 52 of the HCU 40 reads the BG results at 502 to begin the analysis for the high-pattern trend detection. At 504, a decision is made as to whether the result is higher than a pre-set high limit “HIGH.” If true then the logic reads at 506 BG results collected from prior 5 days that are NOT utilized as part of any detected pattern. At 508, the logic checks to see if the Prior BG results or most recent result in step 506 are greater than a HIGH limit and if true it is determined at 510 as to whether the Prior BG result falls was in a prior day at 510, within a time window (e.g., 3 hours) spanning the time at which the most recent BG results was taken at 512, tagged or flagged as a “Before Meal” measurement at 514, and at least 3 such results found at 516 then in such case, a high pattern is recorded for these results. In this example, if the most recent BG result was taken at 9:00 A.M., the Prior BG must be: (a) higher than the HIGH limit; (b) taken at any time between 6:00 AM and 12 noon on one of the prior 5 days; (c) flagged as Before Meal; (d) with at least 3 such measurements fitting these thresholds (preferably within a three hour time window). Returning back to decision step 508, if the most recent result is not greater than the HIGH limit then the process flows to 520 at which the system checks to see if additional results were transferred while logic process from 504-518 was running. If true at 520, the process flow back to the exclusionary step 506 and steps 508-518 are utilized once more. If is determined to be false at 520, the process flows to decision 428 to determine if there are HIGH patterns identified and stored in the HCU 40. If true, the HCU 40 annunciates a high pattern trend alert at 524.

Returning to process 500, if the process returns a false at 504, the flow proceeds to 526 to determine if there are updates to the results. Assuming that no new results were transferred while steps 508-518 were running, then the logic ends at 528. In the preferred embodiments, the window of X hours includes any numerical value from about 1 to about 6 hours (or in minutes) and the N number of days may range from about 2 to about 21 days. In another preferred embodiment, the window of X hours include about 3 hours and the N number of days may range from about 2 to about 30 days, and most preferably from about 2 to about 5 days. In a further preferred embodiment, the N number of days may range from about 2 days to about 90 days. It is noted that the word “days” denote any 24 hour period which may have its start time coinciding with the commonly understood starting point (e.g., 4 AM-8 AM) of a user.

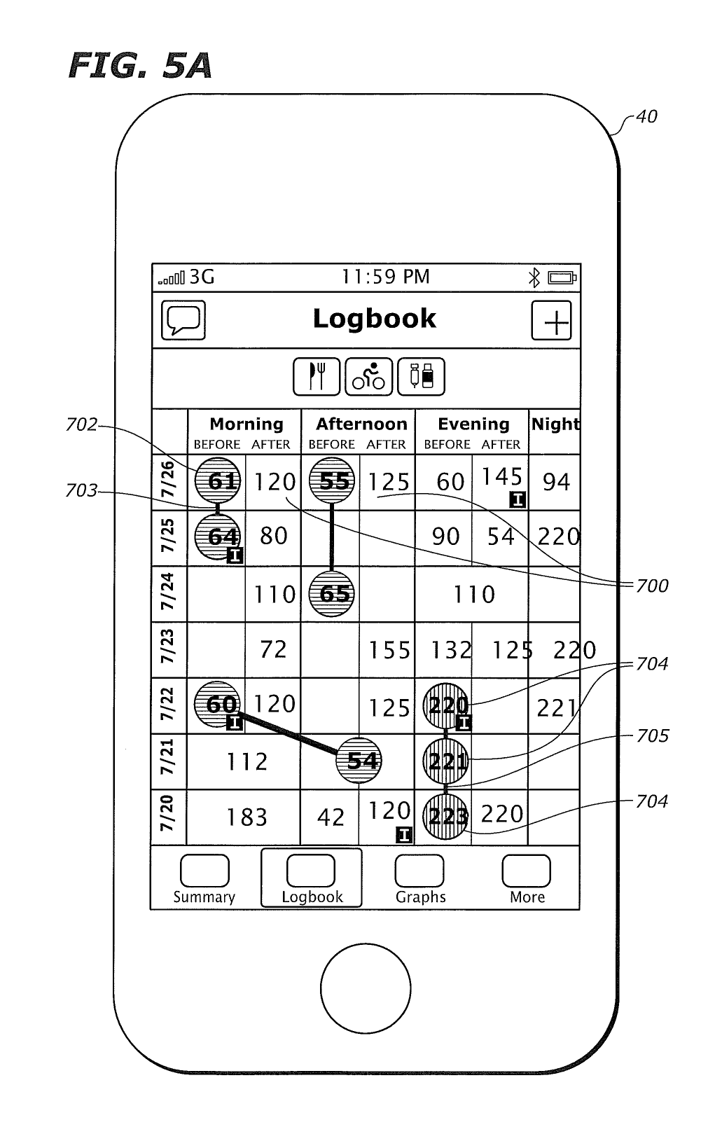

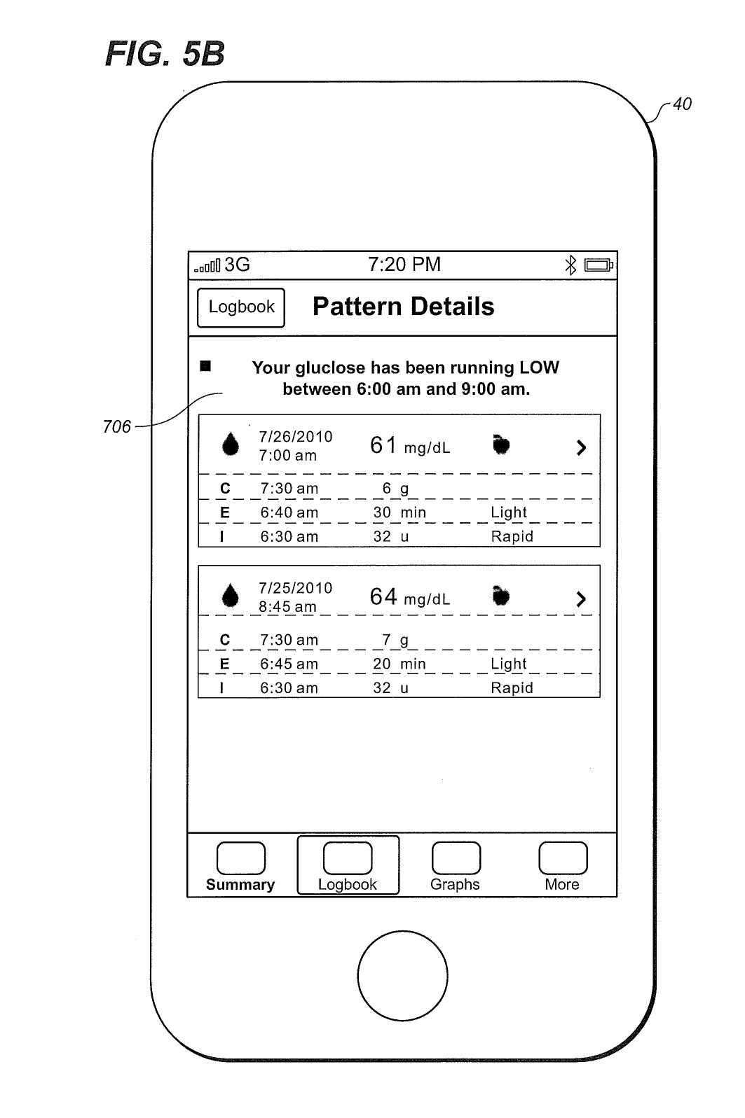

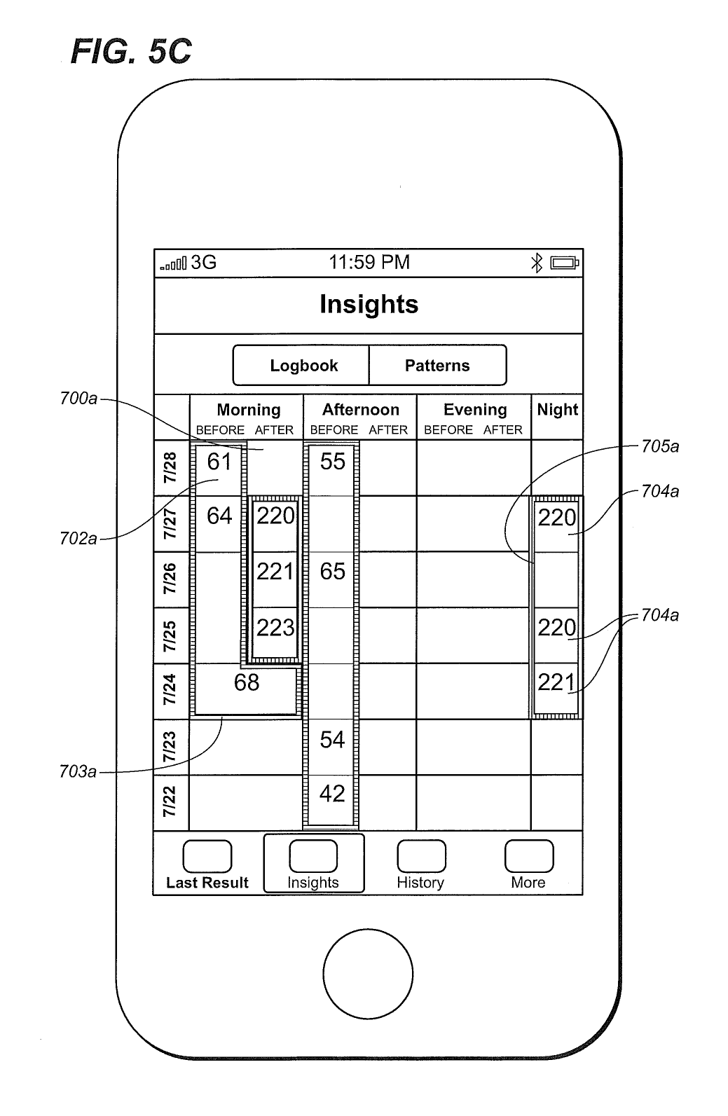

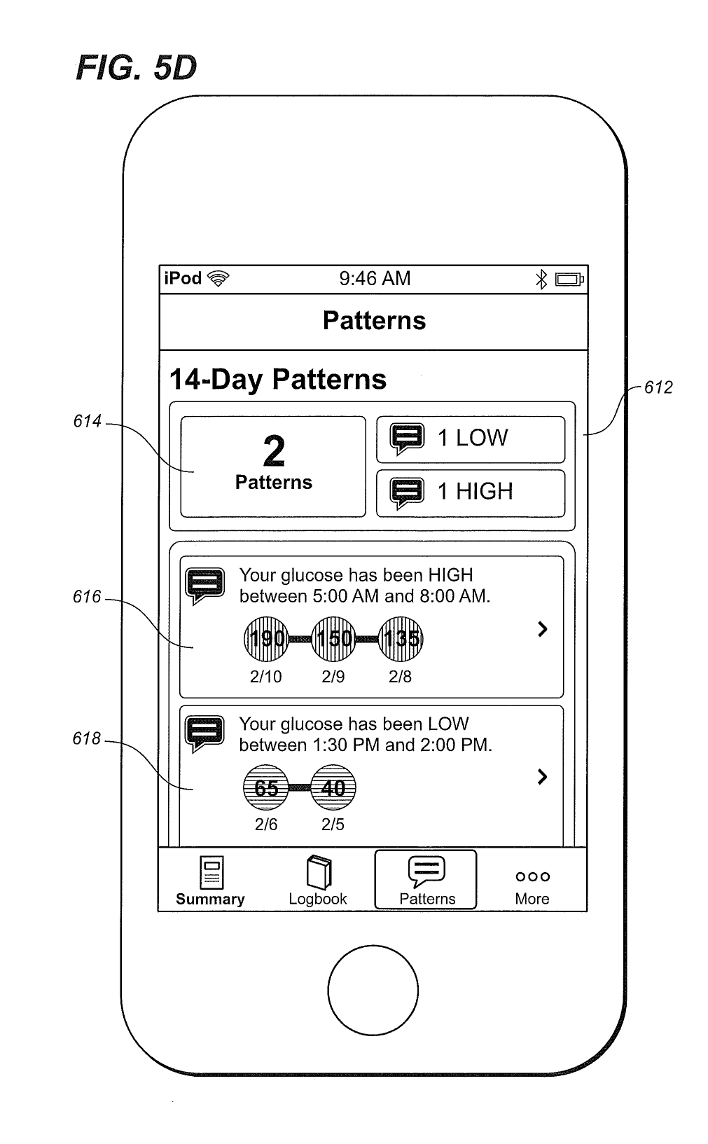

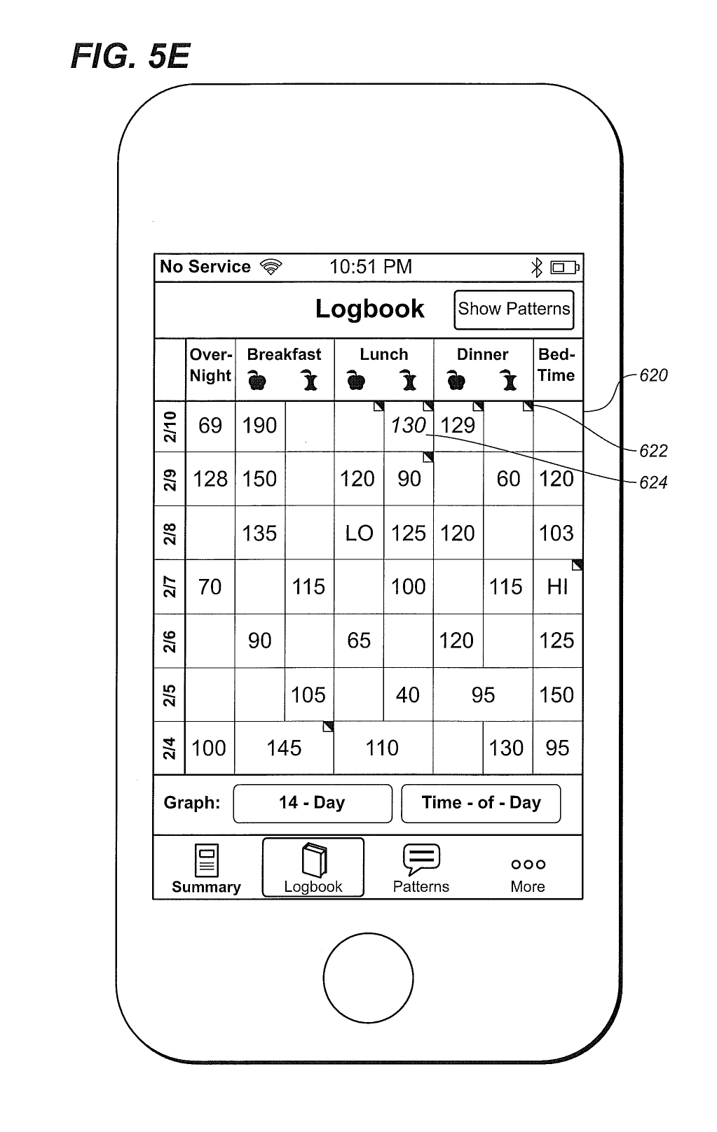

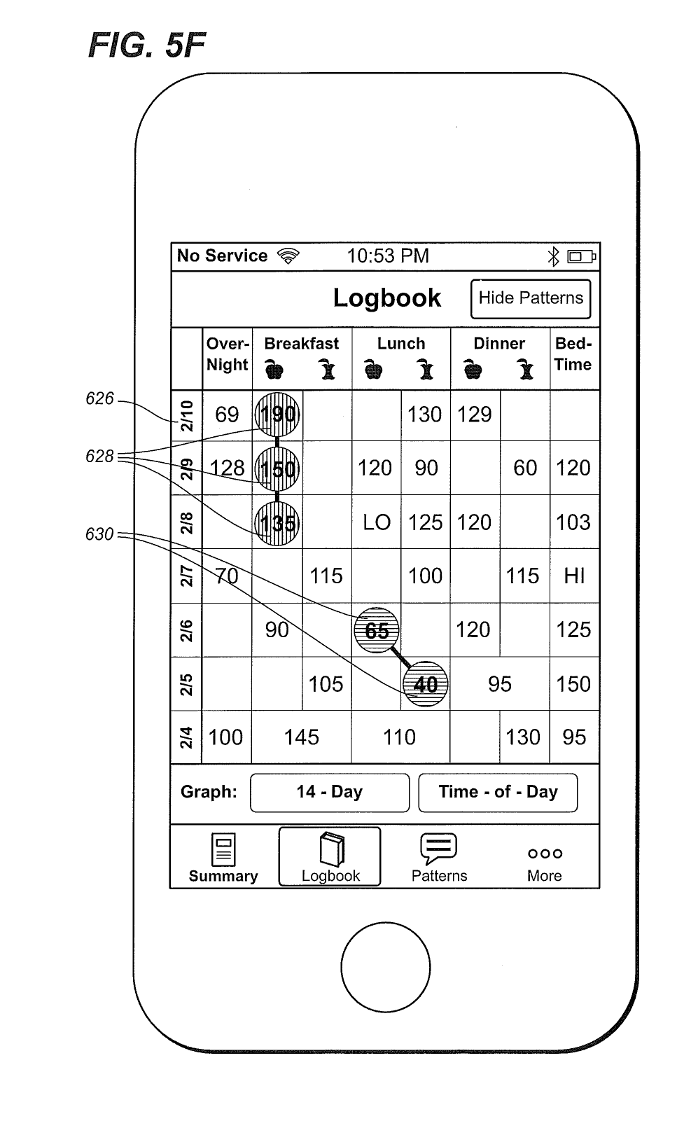

The high patterns or low patterns are stored in the HCU 40 and annunciated to the user in a unique manner. Specifically, as shown in FIG. 5A, the display of the HCU 40 can be controlled by its processor to evaluate whether the measurements stored in the HCU are part of one or more patterns. If the results are not part of any high or low patterns, the results, (shown here, for example, the result 700 denoting the value “120” in the “Morning” column on “July 26” as an “After Meal” measurement) are displayed such that its brightness is dimmed substantially in relation to other indicia on the screen. Where the results are part of a low-trend (e.g., reference 702 denoting a low trend in a “Morning” time period for both July 25 and 26^{th}) the results are displayed as a first indicia such as for example, a circle or a polygon in a first color such as, for example, a solid circle with a connector 703 between each of the solid circles. A numerical value of the measurement may also be provided as an overlay on the indicia, icon, or polygon. Where the results are part of a high-trend (e.g., reference 704 denoting a high trend the “Evening” time periods for July 20, 21, and 22), the results are displayed as a second indicia such as, for example, a circle or a polygon in a second color different from the first color. A graphical icon, symbol, or connector 705 may be utilized to indicate that these values are part of a high trend in accordance with the logic described herein. Other indicia (e.g., symbol, color, markings) can also be utilized to provide other contextual data relating to the analyte measurement. In this example, the display of HCU 40 can be configured to display the upper case letter “I” to indicate that insulin was taken around the time that the measurement of 64 was obtained.

Referring to FIG. 5C, an alternate display for high or low patterns of FIG. 5A can be provided. For example, the results, (shown here, for example, the result 700a denoting the value “120” in the “Morning” column on “July 26” as an “After Meal” measurement) are displayed such that its brightness is dimmed substantially in relation to other indicia on the screen. Where the results are part of a low-trend (e.g., reference 702a denoting a low trend in a “Morning” time period for July 24^{th}, 25^{th}, and 26^{th}) the results are displayed as a first indicia such as for example, a polygon in a first color such as, for example, the series of connected and merged squares 703a connecting the values on July 24^{th}, 25^{th}, and 26^{th}. A numerical value of the measurement may also be provided inside the polygon. Where the results are part of a high-trend (e.g., reference 704a denoting a high trend the “Night” time periods for July 24^{th}, 25^{th}, and 27^{th}), the results are displayed as a second indicia such as, for example, a polygon in a second color different from the first color. A series of squares merged with each other form polygon 705a may be utilized to indicate that these values are part of a high trend in accordance with the logic described herein.

Where the user desires more details to the trends, the user may touch the relevant indicia in FIG. 5A or 5C, such as for example, the low trend pattern on July 25 and 26. This would cause the HCU 40 to display the data in more detail in FIG. 5B such as, for example, that the measurement of 61 mg/dL was taken at 7:00 AM on Jul. 26, 2010 before a meal (represented by an icon such as an uneaten apple) and other contextual data such as, for example, carbohydrates “C” at 730 AM in the amount of 5 grams, with light exercise “E” at 640 AM for 30 minutes, and injection of rapid-acting insulin “I” of about 3.2 units at 630 AM.

As an alternative to displaying the high trend separately from the low trend (e.g., FIG. 5B), the App of the device can be configured to display messages regarding both patterns in one screen 612 of FIG. 5D. In screen 612, a message field 614 indicates the number of patterns available for review and the type of patterns. Message field 616 indicates the trend (high in this case) and when the trend had occurred along with the details of the blood glucose results and date for such trend. Message field 618 indicates the low trend and when the trend had occurred along with the details of the blood glucose results and date for such trend.

The resulting blood glucose values may be indexed against various indices such as, for example, time, date, flags, trends, meals and any other index suitable to the user to help manage and track diabetes. As shown in FIG. 5E, a log book screen 620 is provided that displays 7 or more days per screen with blood glucose results for each day indexed to the time zone of the day, pre or post meal flags and medication. In FIG. 5E for example, on February 10, the user's test results indicate that before breakfast, the user's blood glucose value was 190 mg/dL and after lunch, the blood glucose value was 130 mg/dL and before dinner, the blood glucose value was 129 mg/dL. The icon indicated by 622 indicates that there is additional information provided here such as, for example, carbohydrates ingested, physical exercise, or medication. Of note, results that are displayed in a handwritten font signify that these were entered manually, and not transmitted from the meter 10 to the device 40. For example, result 624 can be configured to show a hand-written like font to indicate a manually entered value. As an aid to users in visualizing high or low trend patterns, log-book screen 626 in FIG. 5F can be provided in which the results (in the informational screen 620 of FIG. 5E) that are within the predefined range have its intensity reduced so as to be nearly translucent but still visible, and the results 628 that are part of a high trend are displayed within a circle or polygon of a specific color such as, for example, red whereas for results 630 that are part of a low trend, blue so as to emphasize the trend patterns on this screen.

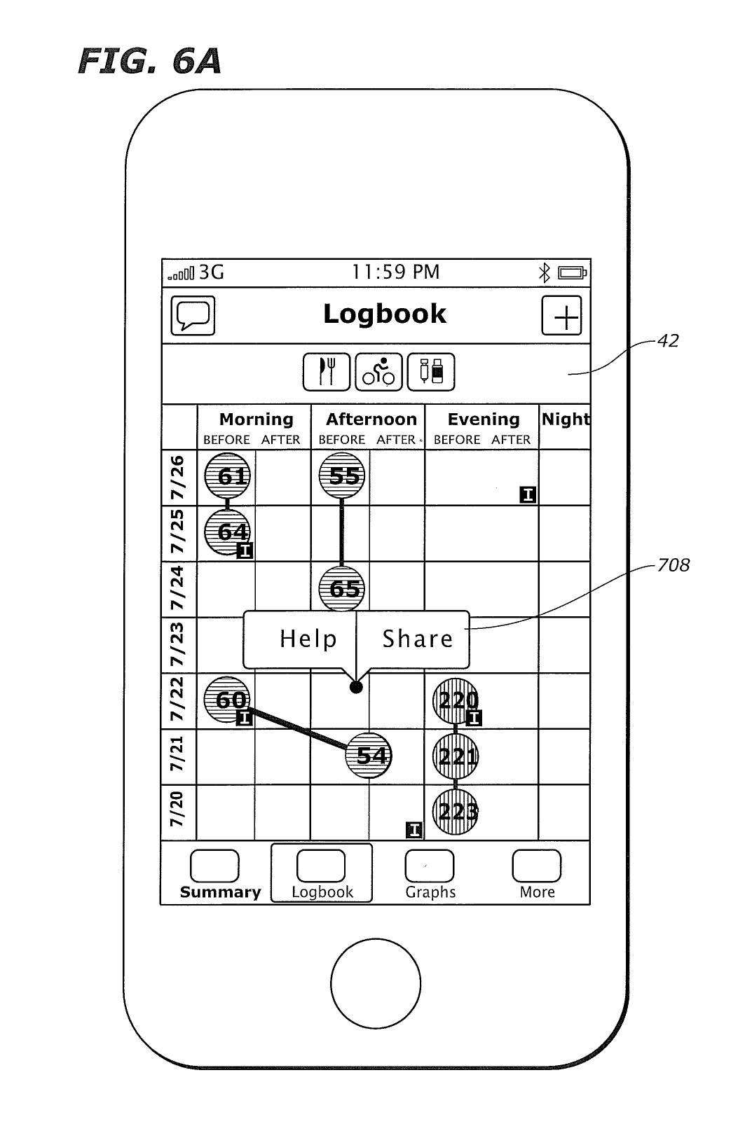

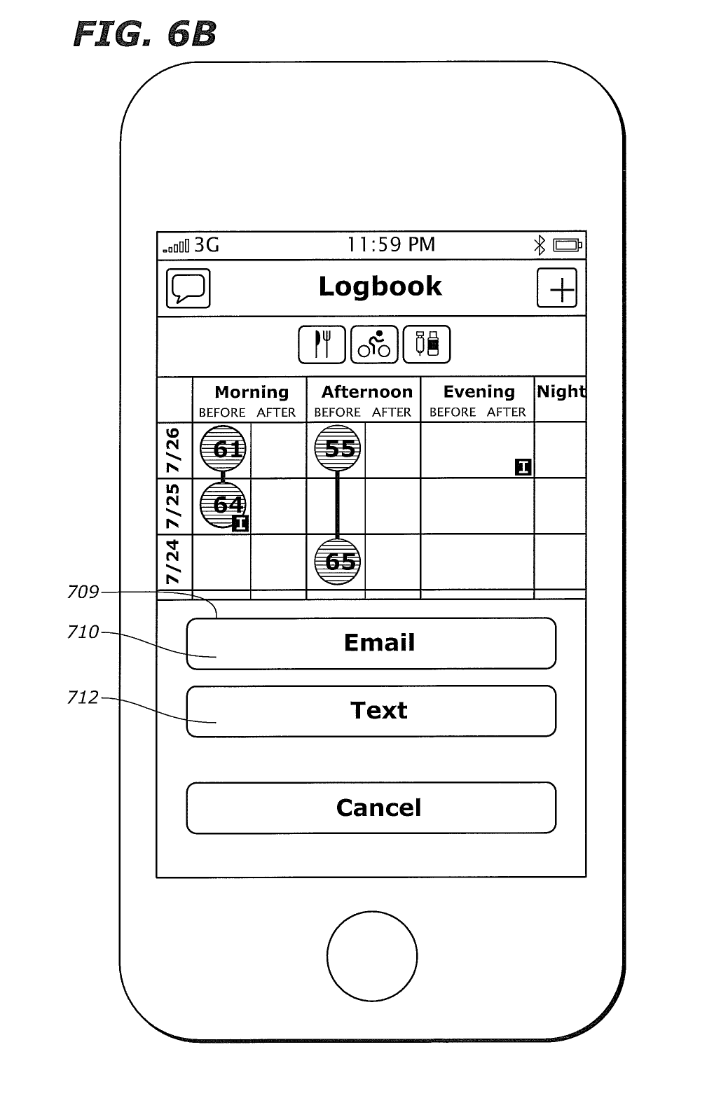

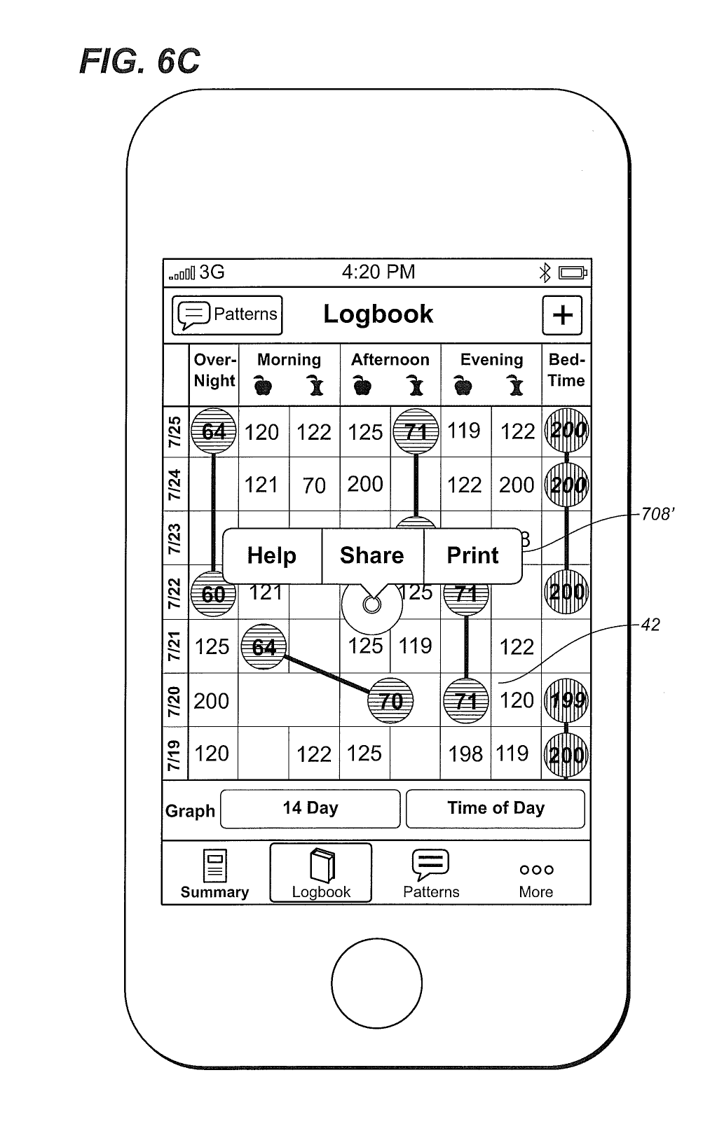

The exemplary system also allows the log-book to be shared with a caretaker or a health care provider or for the user to seek help in interpreting the log-book. This feature is shown in FIGS. 6A and 6B. In FIG. 6A, should the user desires to share the output of the log-book or seek help regarding the use of a log-book, the user simply taps on a suitable open area of the touch screen or touch-sensitive display 40. In another embodiment, the user holds a finger down on the screen for a predetermined amount of time. This initiates a pop-up selection 708 for the user to select between “Help” and “Share.” The pop-up selection can be referred to as a segmented button that provides two or more selectable options.

Selection of “Help” activates a suitable media such as, for example, a video (e.g., a Youtube or Facebook video) on the effects of glucose values trending lower over time or approved articles from health care providers, pop-up with explanatory text, or an acoustic tutorial. Alternatively, selection of “Help” opens a call to a pre-selected phone number or to a website (e.g., diabetes forum or a private Facebook website for diabetics). Selection of “Share” activates an overlay 709 with 3 choices: sending an email with a copy of the log-book data or a screen-captured image of the informational screen to another user; sending a text message that includes textual, video, or audio description of the log-book or image; or canceling this feature. Note that the help/share feature is not only applicable to the logbook, but can be categorically applied to all screens of the communication device. For example, the help/share feature may be applied to a Summary screen (see FIG. 1D) and a graph (see FIG. 6A). In particular, the device overlays a (e.g., a pop-up) help screen on the informational screen upon momentary finger contact on one segmented selection button in which the help screen allows for help information to be displayed over the at least one informational screen and thereafter, the device overlays (via a pop-up) a sharing screen on the informational screen upon momentary finger contact on another segmented selection button that allows for information related to the informational screen to be sent to a different device including another mobile computing device. In the embodiment of FIG. 6C, an overlay or pop-up with three selectable options can be provided. The three selectable options can include “help”, “share”, “print” or any other suitable option such as, for example, “vote” or “rate” and the like. The print option can cause an image or data of the screen to be wirelessly transferred to a printer. Details of the help-share and related pop-ups on a mobile touch-sensitive microcomputing device are provided in WO2009/110941 and U.S. Pat. No. 7,567,849, and incorporated by reference herein. It is noted that while a touch screen interface is one of the preferred embodiments, another embodiment may utilize a digital assistant instead of the touch-screen interface. The digital assistant may be a voice-activated controls and speech-recognition that is built into smartphones such as, for example, the Siri interface built into the iPhone. In such utilization of the Siri interface, the user would use voice command to have Siri transmit the information on the screen, screen capture, or the underlying glucose and insulin data for transmission to another device. In particular, program instructions are provided in the memory and configured for execution by the at least one microprocessor to generate at least one informational screen on the touch-sensitive display indicative of a plurality of analyte measurements stored in the memory. The program instructions would display a segmented selection button on the at least one informational screen upon a voice command to the digital voice assistant to highlight certain fields or areas of the display. Thereafter, the digital voice-activated assistant would overlay a task screen on the at least one informational screen. Thereafter, the digital voice-activated assistant could be commanded to display or annunciate helpful information or to send the information screen (or relevant portions of the screen) to another device.

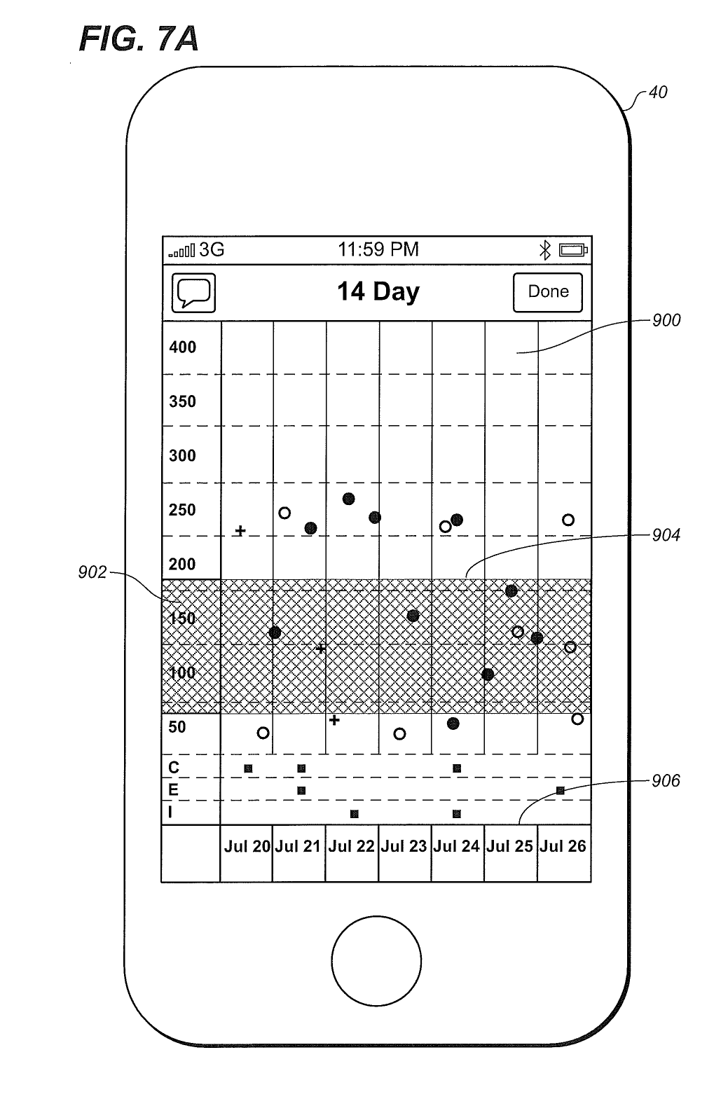

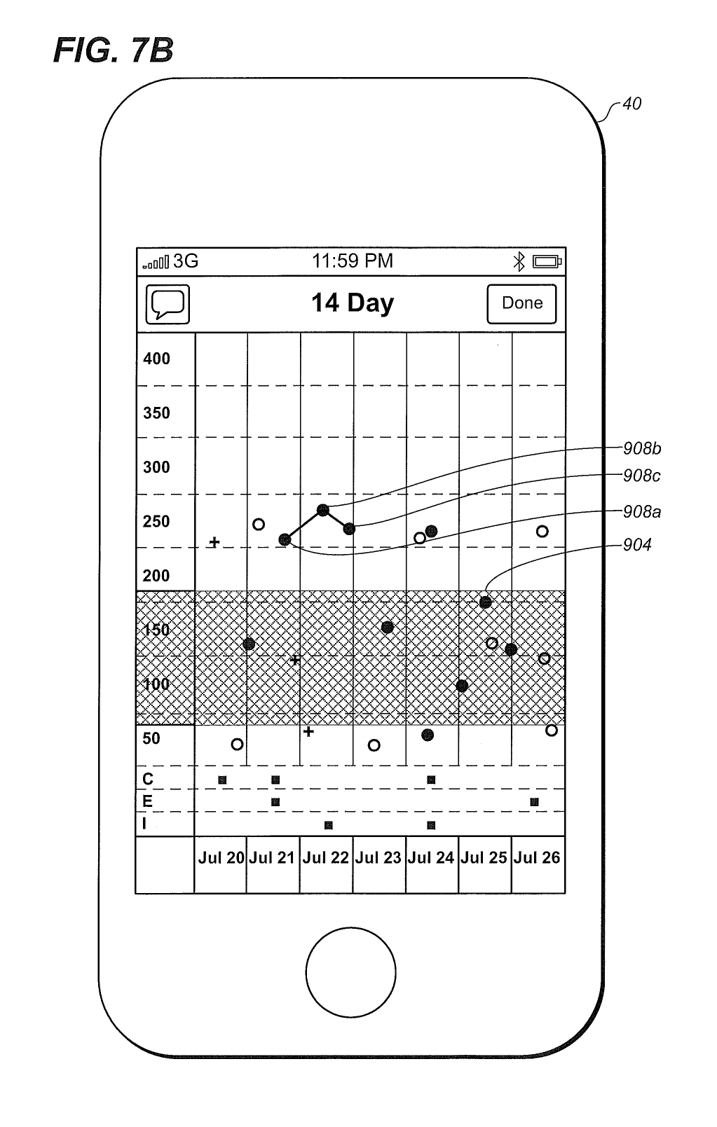

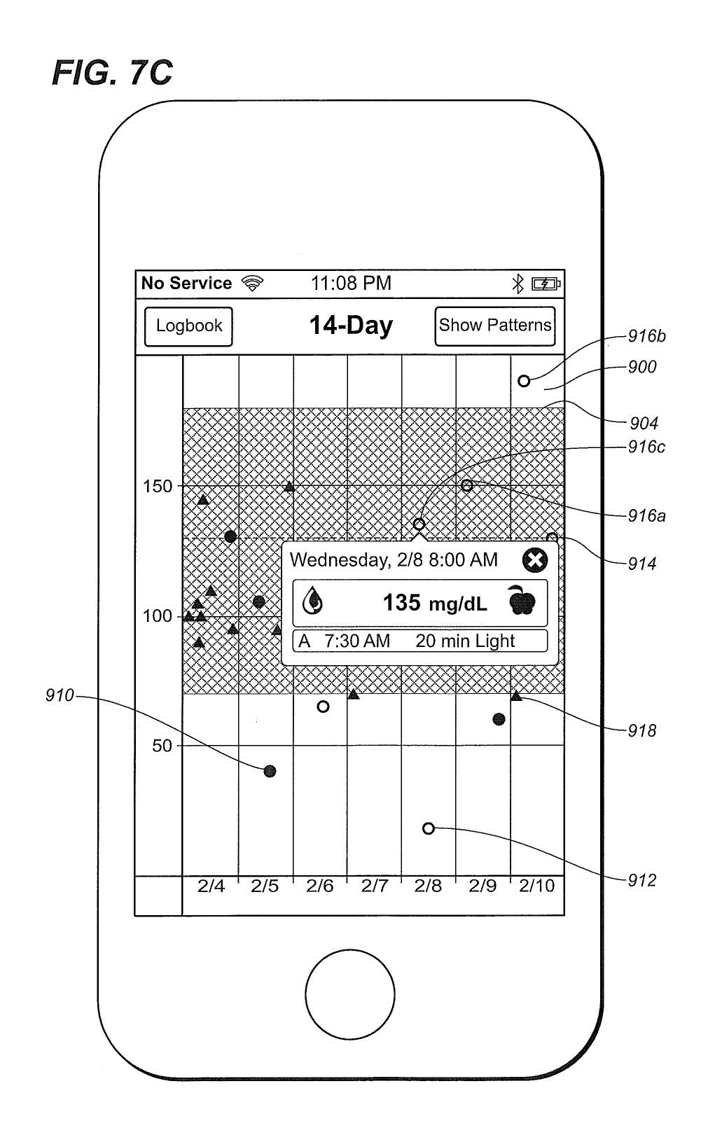

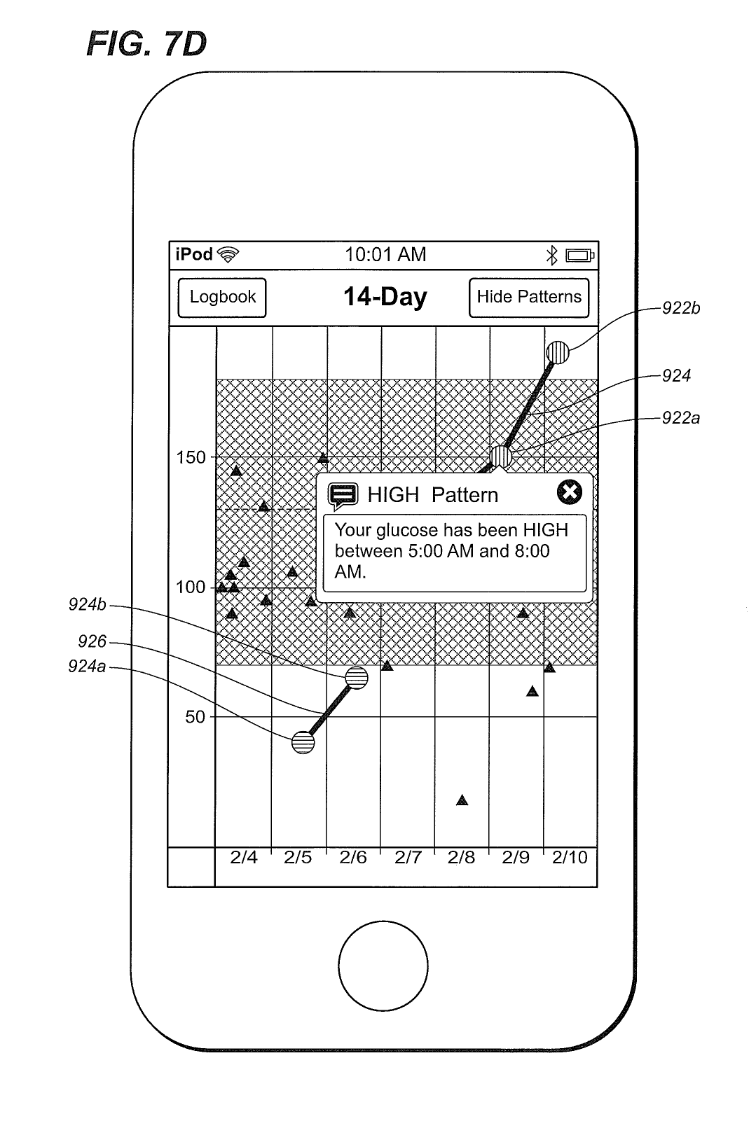

Another feature that the system also provides is the ability to display analyte measurements in a graphical format. In this example, in screen 900 of FIG. 7A, the measurements are plotted in a Cartesian graph with numerical values referenced at 902 for the analyte values from 50 to 400 (in mg/dL) and different indicia to indicate high trend, low trend, carbohydrates, exercise, or insulin over a range of dates as referenced at 906. In screen 800, the graph is overlaid with a semi-transparent rectangle 904 denoting an acceptable range for the analyte measurements from, for example, 60 to 170 (in suitable units such as, mg/dL). A solid circle, polygon or any suitable icon or indicia in a first color may indicate that the measurement belongs to a low-trend pattern; a solid circle, polygon or any suitable icon or indicia in a second color may indicate that the measurement belongs to a high-trend pattern. In FIG. 7B, three measurements denoted by 908a, 908b, and 908c are shown as part of a high-trend determined using one or more of the high-trend pattern determination logic of FIGS. 3A and 3B.

In a preferred embodiment, shown here in FIG. 7C, blood glucose values are displayed with different meanings attached to different icon. In the 14-Day screen 900, low blood glucose value 910 is denoted in a first color such as, for example, blue. If the icon is solid, such as 910, this indicates that the value was obtained after a meal whereas an open icon such as 912 indicates that the value was before a meal. Within the overlay 904 denoting a preset range, a high threshold 914 with respect to before meal results is delineated. Hence, whenever blood glucose results such as 916a, 916b, and 916c are before a meal above the threshold 914, the icon is hollow (e.g., “ [symbol] ”) rather than a solid icon (e.g., “”). For results 918 that have not been tagged as before or after meal, the icon is different from the before meal and after meal icon (e.g., “▴”). The color for icon 918 may also be different from the convention of the high and low results but preferably is the same to reduce confusion. The user may also view the high and low trends by finger tapping the “show patterns” button on screen 900. Once the pattern screen 920 is displayed, here in FIG. 7D, the user may use a finger to touch the icons 922a, 922b, 924a and 924b, over the line delineating the trend in order to obtain more information. For example, in FIG. 7D, the touching of the icons 922a of the high trend graph line 924 brings forth a message with additional information about the trend line such as, for example, “HIGH PATTERN—Your glucose has been HIGH between 5:00 AM and 8:00 AM”. Similarly, touching the low trend line 926 with a finger would bring forth additional information about the low trend. As used herein, the phrases relating to actions by the finger would apply equally to a touch-screen that uses a stylus instead of a finger.

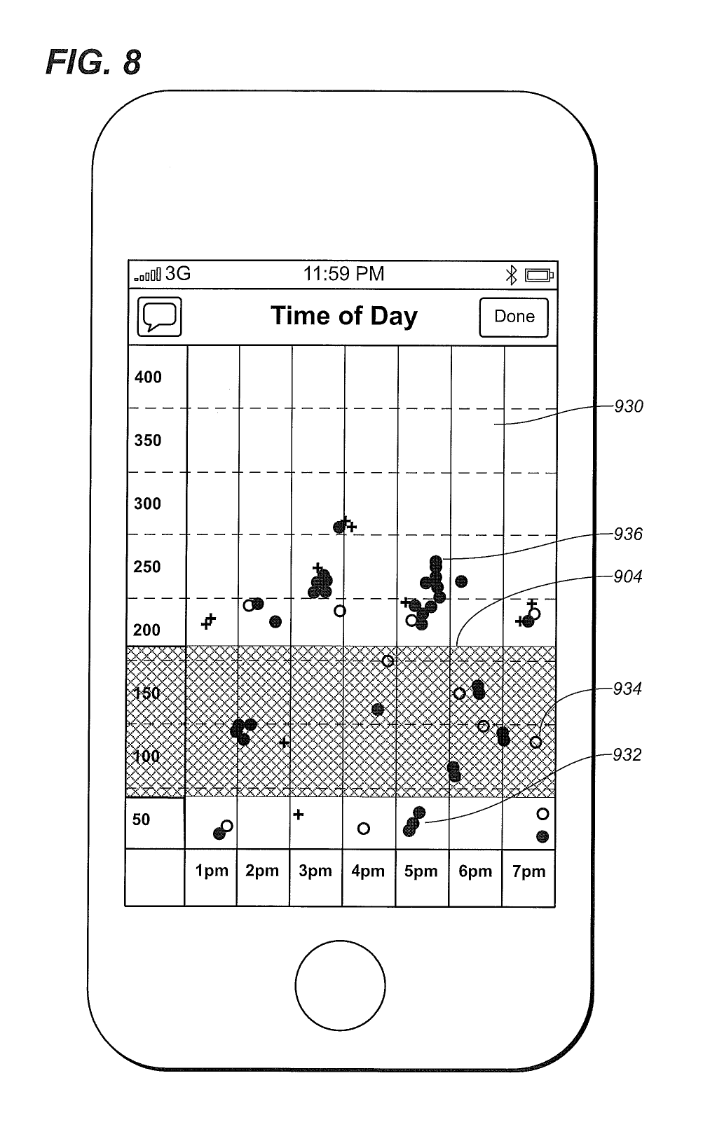

Instead of displaying the measurements plotted against a numerical range and date as in FIGS. 7A and 7B, the HCU 40 may also plot, in screen 930 of FIG. 8, the measured analyte values against a numerical range and time of day irrespective of the number of days. As shown in FIG. 8, measurements 932 that are part of a low-trend over a number of days at around 5 PM are also displayed as a cluster using a second indicia, which may include a solid polygon and a first color. Measurements 936 that are part of a high-trend measured around 5 pm for a number of days are displayed as a cluster of measurements using a first indicia, which may include a solid circle or polygon and a second color different from the first color. Measurements 934 that are not flagged but taken around certain times of the day can be represented by a third indicia, which may include a circle with a third color.

By virtue of the system and processes described herein, a method of notifying a user of high or low trends in blood glucose values obtained with an analyte measurement unit is provided. The method may include the steps of: performing with the microprocessor, a plurality of blood glucose measurements; storing in the memory, the plurality of blood glucose measurements; determining whether a most recent blood glucose measurement is below a first threshold or above a second threshold; evaluating with the microprocessor, whether at least one blood glucose measurement of the plurality of blood glucose measurements performed within a time frame as the most recent blood glucose measurement over a period of N days, is lower than the first low threshold or higher than the second threshold; and upon completion of the evaluating step, annunciating that in the same time frame of at least two days over the N number of days, the plurality of blood glucose measurements indicates a trend lower than the low threshold or a trend higher than a second threshold.

Furthermore, the various methods described herein can be used to generate software codes using off-the-shelf software development tools such as, for example, Visual Studio 6.0, C or C++ (and its variants), and suitable software-development-kit (“SDK”) from Apple, Blackberry, Google, and other less well-known software and hardware providers. The methods, however, may be converted or ported into other software languages depending on the requirements and the availability of new software languages for coding the methods. Additionally, the various methods described, once transformed into suitable software codes, may be embodied in any computer-readable storage medium that, when executed by a suitable microprocessor or computer, are operable to carry out the steps described in these methods along with any other necessary steps.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

1. A mobile computing device comprising:
a touch-sensitive display that is responsive to commands by finger contact;
a memory;
at least one microprocessor coupled to the display and memory; and
program instructions stored in the memory and configured for execution by the at least one microprocessor to:
generate at least one informational screen on the touch-sensitive display indicative of a plurality of analyte measurements stored in the memory;
display a segmented selection button on the at least one informational screen upon finger contact longer than a preset time;
overlay a help screen on the at least one informational screen upon momentary finger contact on one segmented selection button in which the help screen allows for help information to be displayed over the at least one informational screen;
overlay a sharing screen on the at least one informational screen upon momentary finger contact on another segmented selection button that allows for information related to the at least one informational screen to be sent to a different device including another mobile computing device.

2. The device of claim 1, in which the informational screen comprises a screen selected from one of a logbook screen, a logbook screen with high low trends indicia, a graphical screen, or summary screen for the touch-sensitive display.

3. The device of claim 1, in which the different device comprises at least one of a desktop computer, server, printer, and combinations thereof.

4. The device of claim 1, in which the at least one microprocessor is further programmed to:
(a) store a plurality of analyte measurements;
(b) determine whether a most recent analyte measurement at a given time during a day is below a first threshold;
(c) evaluate whether at least one analyte measurement of the plurality of analyte measurements performed within a time frame of X hours about the given time of the most recent analyte measurement over a period of N days, is lower than the first threshold,
(d) ascertain whether at least two analyte measurements of the plurality of analyte measurements performed within a time frame of X hours about the given time of the most recent analyte measurement over a period of N days, are higher than the second threshold; and
(e) upon completion of the evaluate and ascertain, annunciate that in the same time frame of at least two days over the N number of days, the plurality of analyte measurements indicates a trend lower than the low threshold or a trend higher than a second threshold.

5. The device of claim 4, in which the annunciate comprises a display of at least one trend and plurality of analyte measurements on the touch screen display of the mobile communication device in a table having multiple rows and multiple columns with respective row header and column header, the column header signifying different time periods during a day with subdivisions of each of the column header to signify a before meal or after meal analyte measurement within each time period of the day, and the row header signifying the date of each analyte measurement, and in which numerical values representing analyte values identified as part of one analyte trend are represented by a first indicia and as part of another analyte trend by a second indicia different from the first indicia.

6. A mobile computing device comprising:
a touch-sensitive display that is responsive to commands by finger contact;
memory;
at least one microprocessor coupled to the display and memory; and
program instructions stored in the memory and configured for execution by the at least one microprocessor to:
(a) store a plurality of analyte measurements;
(b) determine whether a most recent analyte measurement at a given time during a day is below a first threshold;
(c) evaluate whether at least one analyte measurement of the plurality of analyte measurements performed within a time frame of X hours about the given time of the most recent analyte measurement over a period of N days, is lower than the first threshold,
(d) ascertain whether at least two analyte measurements of the plurality of analyte measurements performed within a time frame of X hours about the given time of the most recent analyte measurement over a period of N days, are higher than the second threshold;
(e) upon completion of the evaluate and ascertain, annunciate that in the same time frame of at least two days over the N number of days, the plurality of analyte measurements indicates a trend lower than the low threshold or a trend higher than a second threshold;
(f) generate at least one informational screen on the touch-sensitive display indicative of a plurality of analyte measurements stored in the memory;
(g) display a segmented selection button on the at least one informational screen upon finger contact longer than a preset time;
(h) overlay a help screen on the at least one informational screen upon momentary finger contact on one segmented selection button in which the help screen allows for help information to be displayed over the at least one informational screen; and
(i) overlay a sharing screen on the at least one informational screen upon momentary finger contact on another segmented selection button that allows for information related to the at least one informational screen to be sent to a different device including another mobile computing device.

7. The device according to claim 6, in which the informational screen comprises a screen selected from one of a logbook screen, a logbook screen with high low trends indicia, a graphical screen, or summary screen for the touch-sensitive display.

8. The device of claim 7, in which the different device comprises at least one of a desktop computer, server, printer, and combinations thereof.

9. The device of claim 1, in which the microprocessor is programmed to display the plurality of analyte measurements on the display of the mobile communication device in a table having multiple rows and multiple columns with respective row header and column header, the column header signifying different time periods during a day with subdivisions of each of the column header to signify a before meal or after meal analyte measurement within each time period of the day, and the row header signifying the date of each analyte measurement, and in which numerical values representing analyte values identified as part of one analyte trend are represented by a first indicia and as part of another analyte trend by a second indicia different from the first indicia.

10. The device of claim 1, in which the microprocessor is further programmed to confirm whether the most recent analyte measure was flagged as one of predetermined conditions including (a) a measurement made before a meal or (b) during a fasting period.

11. The device of claim 10, in which the microprocessor is further programmed to confirm whether the most recent analyte measure is below a first threshold as the predetermined condition.

12. The device of claim 11, in which the N number of days comprises any number from about 2 to about 14 and the X hours comprises any number between about 0 and about 7 hours.

13. The device of claim 11, in which the X hours comprises any number from about 0 to about 3 hours.

14. The device of claim 11, in which the first threshold comprises about 70 mg of glucose per deciliter of blood and the second threshold comprises about 150 mg of glucose per deciliter of blood.

15. A method of notifying a user of high or low trends in blood glucose values obtained with an analyte measurement unit and used in conjunction with a mobile communication device, each having a microprocessor coupled to respective displays and memory storage devices, the method comprising:
physically transforming with the analyte measurement unit, an analyte in a physiological fluid into an enzymatic by-product and in the process provides a measurement of the analyte in the fluid;
storing in the memory of the analyte measurement unit, one or more of the analyte measurements;
determining with the mobile communication device, whether a most recent analyte measurement at a given time during a day is below a first threshold;
evaluating with the mobile communication device, whether at least one analyte measurement of the plurality of analyte measurements performed within a time frame of X hours about the given time of the most recent analyte measurement over a period of N days, is lower than the first threshold;
annunciating that, in the same time frame over the N number of days, the plurality of analyte measurements including the at least one analyte measurement indicates an analyte trend lower than the low threshold, the annunciating further comprises:
displaying an informational screen on the touch-sensitive display indicative of the analyte trend;
displaying a segmented selection button on the at least one informational screen upon finger contact longer than a preset time;
overlaying a help screen on the at least one informational screen upon momentary finger contact on one segmented selection button in which the help screen allows for help information to be displayed over the at least one informational screen.

16. The method of claim 15, further comprising overlaying a sharing screen on the at least one informational screen upon momentary finger contact on another segmented selection button that allows for information related to the at least one informational screen to be sent to a different device including another mobile computing device.

17-29. (canceled)

30. A diabetes management system comprising:
a glucose test strip; and
an analyte measurement unit comprising:
a housing including a test strip port configured to receive the glucose test strip;
a measurement microprocessor coupled to the test strip port to provide data regarding an amount of glucose measured in a user's physiological fluid deposited on the test strip, the microprocessor further coupled to a memory;
a mobile communication unit comprising a mobile processor coupled to a display, one of the measurement microprocessor or the mobile microprocessor being programmed to:
(a) measure an analyte in a physiological fluid to provide an analyte measurement;
(b) store one or more of the analyte measurements;
(c) determine whether a most recent analyte measurement at a given time during a day is below a first threshold;
(d) evaluate whether at least one analyte measurement of the plurality of analyte measurements performed within a time frame of X hours about the given time of the most recent analyte measurement over a period of N days, is lower than the first threshold,
(e) ascertain whether at least two analyte measurements of the plurality of analyte measurements performed within a time frame of X hours about the given time of the most recent analyte measurement over a period of N days, are higher than the second threshold; and
(f) upon completion of one of the evaluate and ascertain, annunciate that in the same time frame of at least two days over the N number of days, the plurality of analyte measurements indicates a trend lower than the low threshold or a trend higher than a second threshold;
(j) generate at least one informational screen on the touch-sensitive display indicative of a plurality of analyte measurements stored in the memory;
(k) display a segmented selection button on the at least one informational screen upon finger contact longer than a preset time;
(l) overlay a help screen on the at least one informational screen upon momentary finger contact on one segmented selection button in which the help screen allows for help information to be displayed over the at least one informational screen; and
(g) overlay a sharing screen on the at least one informational screen upon momentary finger contact on another segmented selection button that allows for information related to the at least one informational screen to be sent to a different device including another mobile computing device.

31. The system of claim 30, in which the processor is configured to display the plurality of analyte measurements on the display of the mobile communication device in a table having multiple rows and multiple columns with respective row header and column header, the column header signifying different time periods during a day with subdivisions of each of the column header to signify a before meal or after meal analyte measurement within each time period of the day, and the row header signifying the date of each analyte measurement, and in which numerical values representing analyte values identified as part of one analyte trend are represented by a first indicia and as part of another analyte trend by a second indicia different from the first indicia.

32. The system of claim 30, in which the microprocessor is further programmed to confirm whether the most recent analyte measure was flagged as one of predetermined conditions including (a) a measurement made before a meal or (b) during a fasting period.

33. The system of claim 30, in which the microprocessor is further programmed to confirm whether the most recent analyte measure is below a first threshold as the predetermined condition.

34. The system of claim 30, in which the recent N number of days comprises any number from about 2 to about 14 and the X hours comprises any number between about 0 and about 7 hours.

35. The system of claim 30, in which the X hours comprises any number from about 0 to about 3 hours.

36. The system of claim 30, in which the first threshold comprises about 70 mg of glucose per deciliter of blood and the second threshold comprises about 150 mg of glucose per deciliter of blood.

37. A method of notifying a user of high or low trends in blood glucose values obtained with an analyte measurement unit and used in conjunction with a mobile communication device, each of the unit and device having a microprocessor coupled to memory storage devices, the mobile communication device including a touch screen or touch-sensitive display, the method comprising:
initiating with the analyte measurement unit, a physical transformation of an analyte in a physiological fluid into an enzymatic by-product and in the process provide a measurement of the analyte in the fluid;
storing in the memory of the analyte measurement unit, one or more of the analyte measurements;
evaluating the one more of the analyte measurements to determine one or more of a high trend in which blood glucose values over a set time frame is increasing or a low trend in which blood glucose values over the set time frame is decreasing;
displaying, on the touch screen, an informational screen indicative of the one or more analyte measurements including the high or low trend;
upon contact of a finger on the informational screen for a duration longer than a timed threshold, displaying a segmented button that provides at least two finger selectable options;
upon a finger tap on the informational screen of one of the at least two finger selectable options, annunciating information related to the informational screen indicative of the one or more analyte measurements including the high or low trend; or
upon a finger tap on the informational screen of the other of the at least two finger selectable options, allowing data representing the informational screen to be sent to a different device including another mobile communication device, server, or printer.

38. The method of claim 37, in which the at least two finger selectable options comprise a print option, a share option, or a help option.

39. The method of claim 38, in which the informational screen comprises a screen selected from one of a logbook screen, a logbook screen with high low trends indicia, a graphical screen, or summary screen.
